(19) United States
(12) Patent Application Publication
(10) Pub. No.: US 2025/0282164 A1
(43) Pub. Date: Sep. 11, 2025

(54) CASSETTE INCLUDING PROTRUSION CONFIGURED TO CONTACT WIDTHWISE CENTER PORTION OF INK RIBBON TO CAUSE INK RIBBON TO BE CURVED

(71) Applicant: BROTHER KOGYO KABUSHIKI KAISHA, Nagoya (JP)

(72) Inventor: Akinori HANADA, Nagoya (JP)

(21) Appl. No.: 19/071,135

(22) Filed: Mar. 5, 2025

(30) Foreign Application Priority Data
Mar. 6, 2024 (JP) 2024-034251

(51) Int. Cl. B41J 32/00; B41J 15/04; B41J 35/04; B41J 35/38

(52) U.S. Cl. CPC B41J 32/00; B41J 15/044; B41J 35/04; B41J 35/38

(57) ABSTRACT

A cassette includes: a lower case having a box-like shape; a ribbon roll which is a roll of an ink ribbon; a take-up spool configured to take up the ink ribbon from the ribbon roll; and a protrusion provided in the lower case. The lower case includes: a front wall; a rear wall; a left wall; a right wall; a first inner wall; a second inner wall; a third inner wall; and a fourth inner wall. The protrusion protrudes rightward from a portion of the fourth inner wall other than a front edge and a rear edge of the fourth inner wall. The protrusion is configured to contact a widthwise center portion of the ink ribbon to cause the ink ribbon to be curved along a width of the ink ribbon so that the widthwise center portion of the ink ribbon protrudes rightward.

### REFERENCE TO RELATED APPLICATIONS

This application claims priority from Japanese Patent Application No. 2024-034251 filed on Mar. 6, 2024. The entire content of the priority application is incorporated herein by reference.

### BACKGROUND ART

Cassettes including ink ribbons for use in printers are known. For example, a conventional cassette includes a first frame part, a second frame part, an auxiliary tape roll, and a take-up spool. The second frame part accommodates therein the auxiliary tape roll and the take-up spool. The auxiliary tape roll is configured by winding an ink ribbon into a roll. The take-up spool is configured to take up the ink ribbon from the auxiliary tape roll.

The second frame part includes a front wall, a rear wall, a left wall, and a right wall. The front wall and the rear wall are arranged in a front-rear direction. The left wall and the right wall are arranged in a left-right direction. The second frame part further includes a first inner wall, a second inner wall, a third inner wall, and a fourth inner wall. The first inner wall and the second inner wall are arranged in this order from front to rear at positions between the front wall and the rear wall. The third inner wall and the fourth inner wall are arranged in this order from left to right at positions between the left wall and the right wall.

The third inner wall has a front edge that is connected to a left edge of the first inner wall. The third inner wall also has a rear edge that is connected to a left edge of the second inner wall. The fourth inner wall has a rear edge that is connected to a right edge of the second inner wall.

The second frame part is formed with an exposed area. The exposed area extends from a space between a right edge of the front wall and a right edge of the first inner wall to a space between a front edge of the fourth inner wall and a front edge of the right wall. The ink ribbon is drawn off the auxiliary tape roll, passes sequentially through a portion between the left wall and the third inner wall, a portion between the front wall and the first inner wall, the exposed area, and a portion between the fourth inner wall and the right wall, and is taken up by the take-up spool.

### SUMMARY

In the conventional cassette described above, the ink ribbon may become skewed due to various factors such as part variation, thereby affecting the printing quality produced with the ink ribbon.

In view of the foregoing, it is an object of the present disclosure to provide a cassette that can suppress skewing of an ink ribbon.

In order to attain the above and other object, the present disclosure provides a cassette including: a lower case; a ribbon roll; and a take-up spool. The lower case has a box-like shape. The ribbon roll is accommodated in the lower case. The ribbon roll is a roll of an ink ribbon. The ribbon roll is rotatable about a first axis extending in an up-down direction. The take-up spool is accommodated in the lower case. The take-up spool is configured to take up the ink ribbon from the ribbon roll. The lower case includes: a front wall; a rear wall; a left wall; a right wall; a first inner wall; a second inner wall; a third inner wall; and a fourth inner wall. The front wall extends in both the up-down direction and a left-right direction orthogonal to the up-down direction. The front wall has a right edge. The rear wall extends in both the up-down direction and the left-right direction. The front wall and the rear wall are arranged in a front-rear direction orthogonal to both the up-down direction and the left-right direction. The left wall extends in both the up-down direction and the front-rear direction. The right wall extends in both the up-down direction and the front-rear direction. The left wall and the right wall are arranged in the left-right direction. The right wall has a front edge. The first inner wall extends in both the up-down direction and the left-right direction. The first inner wall is positioned between the front wall and the rear wall. The first inner wall has a left edge and a right edge. The second inner wall extends in both the up-down direction and the left-right direction. The second inner wall is positioned between the front wall and the rear wall and positioned further rearward relative to the first inner wall in the front-rear direction. The second inner wall has a left edge and a right edge. The third inner wall extends in both the up-down direction and the front-rear direction. The third inner wall is positioned between the left wall and the right wall. The third inner wall has a front edge connected to the left edge of the first inner wall and a rear edge connected to the left edge of the second inner wall. The fourth inner wall extends in both the up-down direction and the front-rear direction. The fourth inner wall is positioned between the left wall and the right wall and positioned further rightward relative to the third inner wall in the left-right direction. The fourth inner wall has a front edge and a rear edge connected to the right edge of the second inner wall. The lower case has an exposed area in which the ink ribbon is exposed. The exposed area extends from a portion between the right edge of the front wall and the right edge of the first inner wall to a portion between the front edge of the fourth inner wall and the front edge of the right wall. The lower case defines a conveying path along which the ink ribbon is conveyed in a conveying direction when the take-up spool takes up the ink ribbon from the ribbon roll. The conveying path includes a first part, a second part, the exposed area, and a third part from an upstream side in the conveying direction. The first part passes between the left wall and the third inner wall. The second part passes between the front wall and the first inner wall. The third part passes between the fourth inner wall and the right wall. The cassette further includes: a protrusion protruding rightward from a portion of the fourth inner wall other than the front edge and the rear edge of the fourth inner wall. The protrusion is configured to contact a widthwise center portion of the ink ribbon to cause the ink ribbon to be curved along a width of the ink ribbon so that the widthwise center portion of the ink ribbon protrudes rightward.

In the above structure, the protrusion causes the ink ribbon to be curved along the width of the ink ribbon so that the widthwise center portion of the ink ribbon protrudes rightward. Accordingly, in a case where the ink ribbon attempts to be displaced along the width thereof, a force directed to a direction for restricting the displacement of the ink ribbon is applied to the ink ribbon. Therefore, the cassette according to the above aspect can restrain skewing of the ink ribbon.

### BRIEF DESCRIPTION OF DRAWINGS

FIG. 1 is a perspective view of a printer 1 and a cassette 100.

FIG. 2 is a plan view of an attachment portion 11 to which the cassette 100 is not attached.

FIG. 3 is a plan view of the attachment portion 11 to which the cassette 100 has been attached.

FIG. 4 is a perspective view of the cassette 100.

FIG. 5 is an exploded perspective view of the cassette 100.

FIG. 6 is a cross-sectional view taken along line VI-VI in FIG. 10.

FIG. 7 is a perspective view of the cassette 100 from which a lower cover 70 has been removed.

FIG. 8 is another perspective view of the cassette 100 from which the lower cover 70 has been removed.

FIG. 9 is a perspective view of the lower cover 70.

FIG. 10 is a bottom view of the cassette 100.

FIG. 11 is a bottom view of the cassette 100 from which the lower cover 70 has been removed.

FIG. 12 is a cross-sectional view taken along line XII-XII in FIG. 11.

FIG. 13 is an enlarged view of a region W1 illustrated in FIG. 11.

FIG. 14A is an explanatory view illustrating the way how a printing tape 101 is fixed to a tape spool 102.

FIG. 14B is another explanatory view illustrating the way how the printing tape 101 is fixed to the tape spool 102.

FIG. 15A is a schematic cross-sectional view taken along a plane containing an axis AX3, and illustrating a configuration in which a first gap G1 has a size the same as a size of a second gap G2.

FIG. 15B is a schematic cross-sectional view taken along a plane containing the axis AX3, and illustrating a configuration in which the size of the first gap G1 is greater than the size of the second gap G2.

FIG. 15C is a schematic cross-sectional view taken along a plane containing the axis AX3, and illustrating a configuration in which the size of the first gap G1 is greater than the size of the second gap G2 and the axis AX3 is inclined relative to an up-down direction.

FIG. 16 is a partial perspective view of a cassette 100A, and particularly illustrating a portion in the vicinity of a head front peripheral wall 184.

FIG. 17 is a partial perspective view of a cassette 100B, and particularly illustrating a portion in the vicinity of a head front peripheral wall 284.

FIG. 18 is a perspective view of a cassette 200.

FIG. 19 is a bottom view of the cassette 200.

FIG. 20 is a perspective view of a cassette 300 from which a lower cover 70 has been removed.

FIG. 21 is a bottom view of the cassette 300 from which the lower cover 70 has been removed.

FIG. 22 is a bottom view of a cassette 300A.

FIG. 23 is a perspective view of a cassette 300B.

### DESCRIPTION

Hereinafter, embodiments of the present disclosure will be described while referring to the accompanying drawings. Note that the drawings are used to describe the technical features made possible with the present disclosure. In other words, the configurations and the like illustrated in the drawings are merely illustrative examples, and the present disclosure is not intended to be limited to these configurations.

### First Embodiment

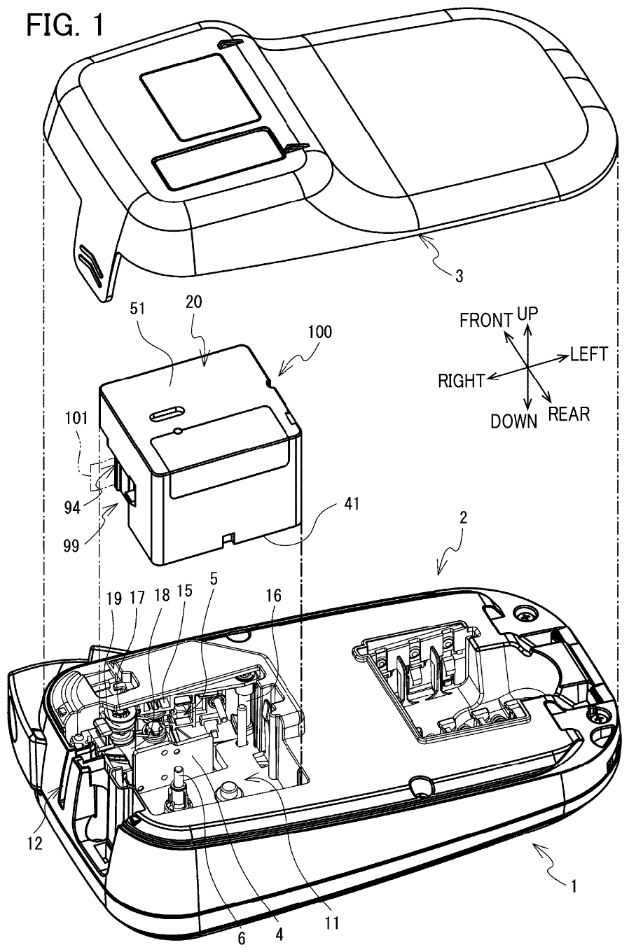

First, a cassette 100 according to a first embodiment will be described with reference to FIGS. 1 through 15. The cassette 100 includes an ink ribbon 105 and a printing tape 101. The cassette 100 is used in a printer 1. The printing tape 101 has a strip-like shape and is a type of printing medium. The ink ribbon 105 has a strip-like shape, and has a surface coated with ink. In the following description, the lower-left side, the upper-right side, the upper-left side, the lower-right side, the lower side, and the upper side in FIG. 1 will be referred to as the right side, the left side, the front side, the rear side, the lower side, and the upper side of the cassette 100 and the printer 1, respectively.

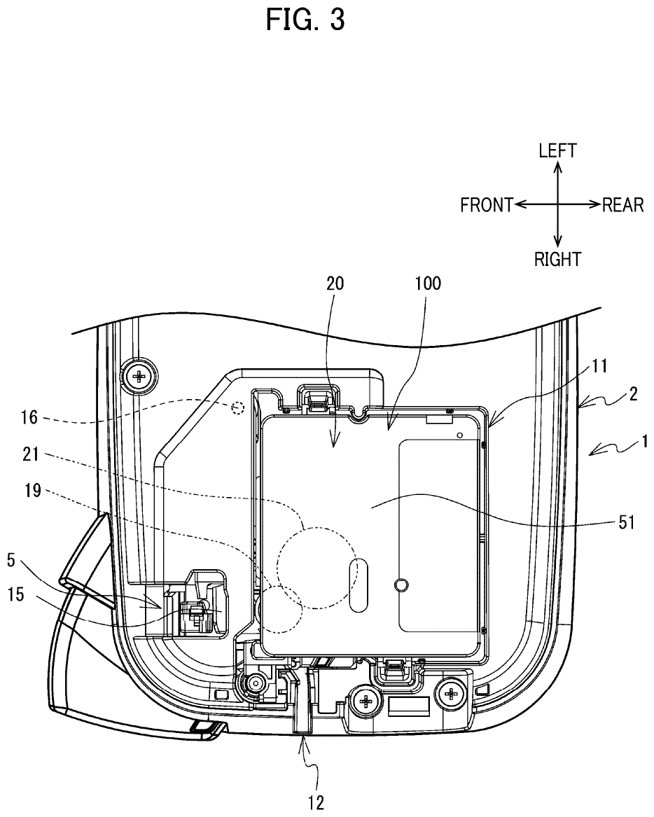

Next, the printer 1 will be described with reference to FIGS. 1 through 3. The printer 1 is a thermal printer configured to perform printing on the printing tape 101 using the ink ribbon 105. The printer 1 includes a housing 2 and a cover 3 (see FIG. 1). The housing 2 has a rectangular parallelepiped shape. An attachment portion 11 is provided in an upper surface of the housing 2 on a right portion thereof. The attachment portion 11 is a recess that is recessed downward from the upper surface of the housing 2. The attachment portion 11 has a shape that conforms to an outer shape of the cassette 100 in a plan view. The cassette 100 is attachable to the attachment portion 11 (see FIG. 3). A discharge opening 12 is formed in a right surface of the housing 2 for discharging, from the housing 2, the printing tape 101 on which printing has been performed. The discharge opening 12 has a slit-like shape and extends in an up-down direction. The cover 3 has a plate shape and extends in both a front-rear direction and a left-right direction. The cover 3 is attachable to the housing 2 from above. In a state where the cover 3 is attached to the housing 2, the cover 3 covers the attachment portion 11 from above. The cover 3 is removable from the housing 2. In a state where the cover 3 is removed from the housing 2, the attachment portion 11 is open upward. Note that the up-down direction, the front-rear direction, and the left-right direction are orthogonal to each other.

The printer 1 also includes a thermal head 4, a platen unit 5, and a rotational shaft 6 which are provided in the attachment portion 11. The thermal head 4 is provided in a right portion in the attachment portion 11, and extends upward from a bottom surface defining the attachment portion 11. The thermal head 4 has a plate-like shape, and extends in both the left-right direction and the up-down direction. The thermal head 4 includes a plurality of heating elements. The heating elements are arranged in the up-down direction on a front surface of the thermal head 4. The selected one or more heating elements of the thermal head 4 are heated, thereby perform printing on the printing tape 101.

The platen unit 5 includes a platen holder 15, a pivot shaft 16, a platen shaft 17, a platen roller 18, and a platen gear 19. The platen holder 15 is disposed in the attachment portion 11 at a position frontward of the thermal head 4. The platen holder 15 extends in the left-right direction, and has an open end open rearward.

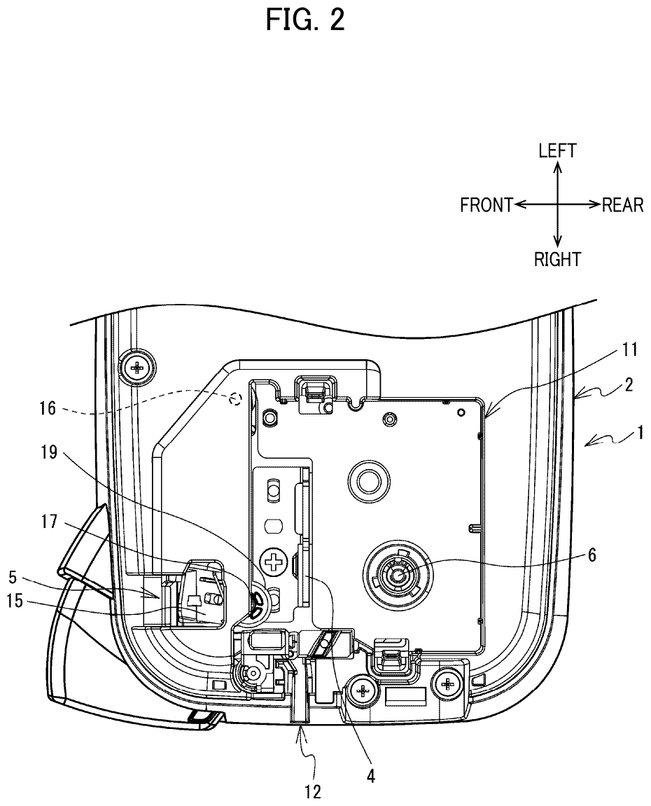

The pivot shaft 16 is disposed on a left end of the platen holder 15, and extends in the up-down direction. The pivot shaft 16 supports the platen holder 15 so that the platen holder 15 is pivotally movable. A lower end of the pivot shaft 16 is fixed to the housing 2. In a plan view, the platen holder 15 is pivotally movable about the pivot shaft 16 so that a right end of the platen holder 15 is moved in the front-rear direction (see FIGS. 2 and 3). The right end of the platen holder 15 is urged by a spring (not illustrated) so that the platen older 15 is pivotally moved frontward about the pivot shaft 16.

The platen shaft 17 is rotatably supported on the right end of the platen holder 15, and extends in the up-down direction. The platen roller 18 extends in the up-down direction and is attached to a lower portion of the platen shaft 17. The platen gear 19 is attached to an upper end of the platen shaft 17.

The rotational shaft 6 is disposed in the attachment portion 11 at a position rearward of the thermal head 4. The rotational shaft 6 extends in the up-down direction. The rotational shaft 6 has a lower end supported by the bottom surface of the attachment portion 11 so that the rotational shaft 6 is rotatable. A conveying motor (not illustrated) is disposed at a position rearward of the attachment portion 11. A driving force of the conveying motor is transmitted to the rotational shaft 6 via a gear train (not illustrated).

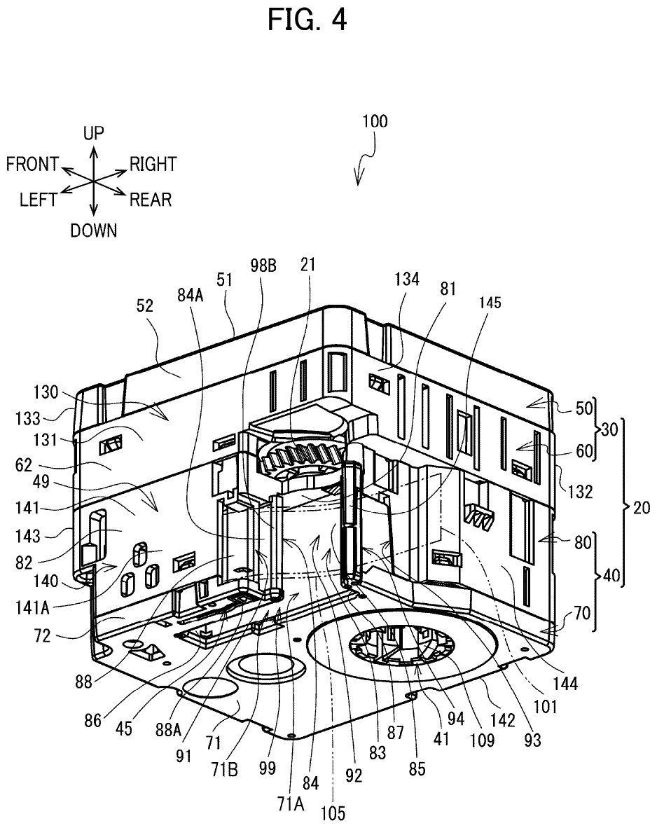

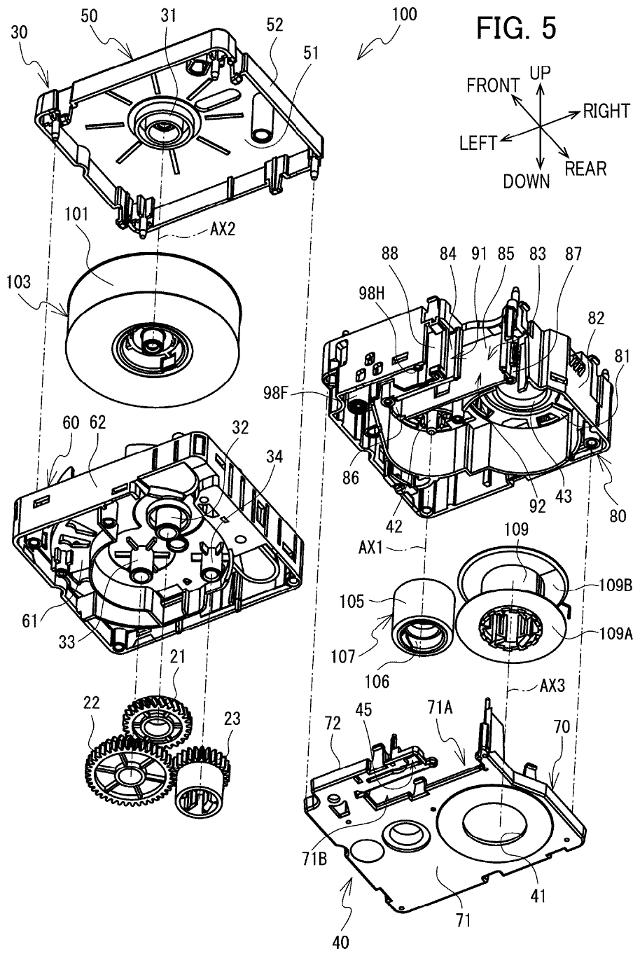

Next, the cassette 100 will be described with reference to FIGS. 4 through 15. As illustrated in FIGS. 4 and 5, the cassette 100 includes a case 20. The case 20 includes a lower case 40 and an upper case 30, and is configured by assembling the upper case 30 with the lower case 40 from above. The lower case 40 constitutes a lower portion of the case 20. The lower case 40 has a box-like shape, i.e., a rectangular parallelepiped shape with a lower-right corner portion thereof being cut out.

A head opening 99 is formed in the lower case 40. The head opening 99 is a recess that is first recessed rearward from a front-right corner of the lower case 40 and is then recessed leftward. The head opening 99 is open downward and diagonally rightward and frontward. Hereinafter, a portion of the lower case 40 which is positioned further frontward relative to the head opening 99 will be referred to as an arm portion 49. The arm portion 49 extends rightward from a left-front corner of the lower case 40. The upper case 30 is positioned further upward relative to the lower case 40, and constitutes an upper portion of the case 20. The upper case 30 has a box-like shape, i.e., rectangular parallelepiped shape.

As illustrated in FIGS. 5 through 8, the cassette 100 also includes a ribbon roll 107, a take-up spool 109, and a tape roll 103 (see FIG. 5). The ribbon roll 107 is accommodated in the lower case 40. The ribbon roll 107 is configured by winding the ink ribbon 105 around a ribbon spool 106. That is, the ribbon roll 107 is a roll of the ink ribbon 105. The ribbon spool 106 has a hollow cylindrical shape that is elongated in the up-down direction. The take-up spool 109 is accommodated in the lower case 40. The take-up spool 109 is configured to take up the ink ribbon 105 from the ribbon roll 107.

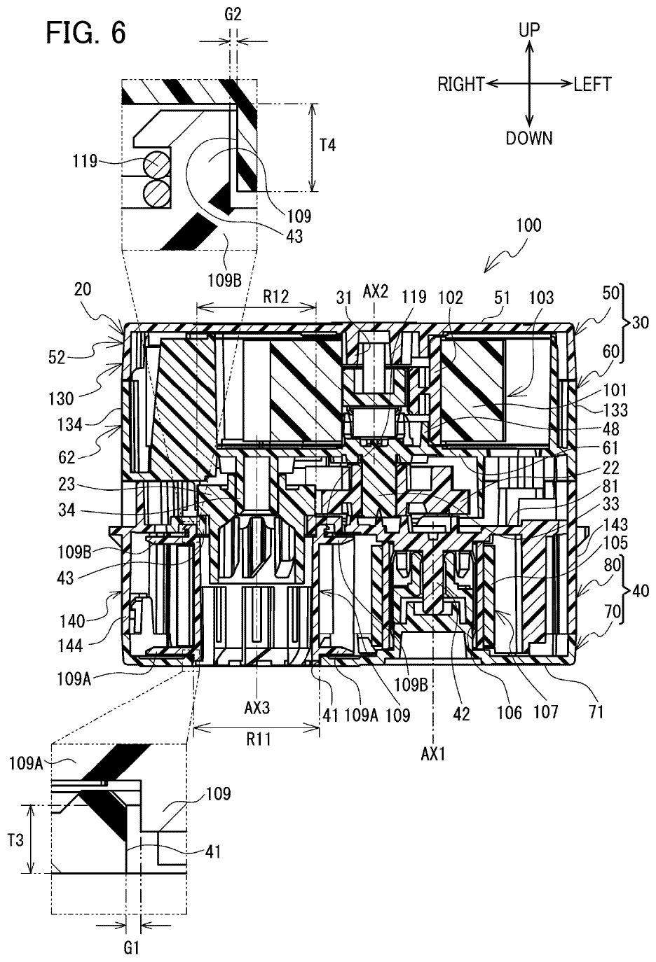

The take-up spool 109 has a cylindrical shape (specifically, a hollow cylindrical shape) that is elongated in the up-down direction. In the present embodiment, a lower end of the take-up spool 109 has an outer diameter R11 that is greater than an inner diameter R12 of an upper end of the take-up spool 109 (see FIG. 6). The take-up spool 109 includes guide discs 109A and 109B. The guide disc 109A is provided at a position just upward of the lower end of the take-up spool 109, and protrudes radially outward from an outer circumferential surface of the take-up spool 109. The guide disc 109B is provided at a position just downward of the upper end of the take-up spool 109, and protrudes radially outward from the outer circumferential surface of the take-up spool 109. The guide discs 109A and 109B are configured to guide the ink ribbon 105, which is wound around the take-up spool 109 between the guide discs 109A and 109B, to restrain the ink ribbon 105 from moving in the up-down direction.

In the present embodiment, the lower end of the take-up spool 109 is a portion of the take-up spool 109 that is further downward relative to the guide disc 109A. The upper end of the take-up spool 109 is a portion of the take-up spool 109 that is further upward relative to the guide disc 109B. A clutch spring 119 (see FIG. 6) is wound around an outer circumference of the upper end of the take-up spool 109. The clutch spring 119 exerts rotational resistance on the take-up spool 109 when the take-up spool 109 takes up the ink ribbon 105 from the ribbon roll 107.

As illustrated in FIGS. 5 and 6, the tape roll 103 is accommodated in the upper case 30. The tape roll 103 is configured by winding the printing tape 101 around a tape spool 102. That is, the tape roll 103 is a roll of the printing tape 101. The tape spool 102 has a hollow cylindrical shape and extends in the up-down direction.

Next, the upper case 30 will be described with reference to FIGS. 4 and 5. As illustrated in FIGS. 4 and 5, the upper case 30 includes an upper wall 51, a support wall 61 (see FIG. 5), and an outer peripheral wall 130. The upper wall 51 constitutes an upper edge of the upper case 30. The upper wall 51 extends in both the front-rear direction and the left-right direction, and has a rectangular shape in a plan view. As illustrated in FIG. 5, the support wall 61 is arranged at a position further downward relative to the upper wall 51 and further upward relative to a lower edge of the upper case 30. The support wall 61 extends in both the front-rear direction and the left-right direction, and has a rectangular shape in a plan view. The upper wall 51 and the support wall 61 are arranged in the up-down direction.

The outer peripheral wall 130 extends from a peripheral edge of the upper wall 51 through a peripheral edge of the support wall 61 to a position further downward relative to the peripheral edge of the support wall 61. The outer peripheral wall 130 includes a front wall 131, a rear wall 132, a left wall 133, and a right wall 134. The front wall 131 constitutes a front edge of the upper case 30, and extends in both the left-right direction and the up-down direction. The rear wall 132 constitutes a rear edge of the upper case 30, and extends in both the left-right direction and the up-down direction. The front wall 131 and the rear wall 132 are arranged in the front-rear direction.

The left wall 133 constitutes a left edge of the upper case 30, and extends in both the front-rear direction and the up-down direction. A front edge of the left wall 133 is connected to a left edge of the front wall 131. A rear edge of the left wall 133 is connected to a left edge of the rear wall 132. The right wall 134 constitutes a right edge of the upper case 30, and extends in both the front-rear direction and the up-down direction. The left wall 133 and the right wall 134 are arranged in the left-right direction. A front edge of the right wall 134 is connected to a right edge of the front wall 131. A rear edge of the right wall 134 is connected to a right edge of the rear wall 132.

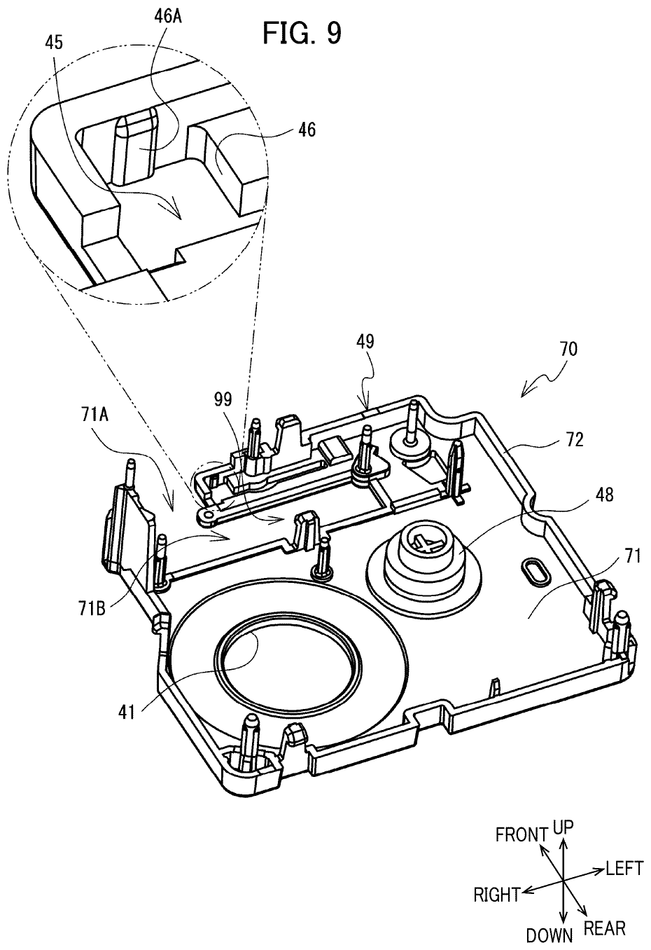

As illustrated in FIG. 5, a support shaft 31 is provided on the upper wall 51. The support shaft 31 is disposed on a center of the upper wall 51 with respect to the front-rear direction and the left-right direction, and protrudes downward from a lower surface of the upper wall 51. The support shaft 31 supports the tape roll 103 in cooperation with a support shaft 48 described later (see FIG. 9). The tape roll 103 is rotatable about an axis AX2. The axis AX2 extends in the up-down direction and passes through a center of the support shaft 31.

Three support shafts 32, 33, and 34 are provided on the support wall 61. The support shaft 32 is disposed on a front-right portion of the support wall 61, and protrudes downward from a lower surface of the support wall 61. The support shaft 32 supports an output gear 21 so that the output gear 21 is rotatable. The support shaft 33 is disposed at a position diagonally leftward and rearward of the support shaft 32, and protrudes downward from the lower surface of the support wall 61. The support shaft 33 supports a coupling gear 22 so that the coupling gear 22 is rotatable. A right-front edge of the coupling gear 22 is in meshing engagement with a left-rear edge of the output gear 21. The support shaft 34 is disposed at a position diagonally rightward and rearward of the support shaft 33, and protrudes downward from the lower surface of the support wall 61. The support shaft 34 supports an input gear 23 so that the input gear 23 is rotatable. A left-front edge of the input gear 23 is in meshing engagement with a right-rear edge of the coupling gear 22.

A tape guide slit (not illustrated) is formed in the support wall 61. The tape guide slit is formed in a rear portion of the support wall 61 for guiding the printing tape 101 from the upper case 30 to a tape insertion opening 44 (described later). The tape guide slit penetrates the support wall 61 in the up-down direction, and extends in the left-right direction.

As illustrated in FIGS. 4 through 6, the upper case 30 includes an upper cover 50 and a lower cover 60, and is configured by assembling the upper cover 50 with the lower cover 60 from above. The upper cover 50 constitutes an upper portion of the upper case 30, and includes the upper wall 51 and an outer peripheral wall 52. The outer peripheral wall 52 extends downward from the peripheral edge of the upper wall 51. The lower cover 60 constitutes a lower portion of the upper case 30, and includes the support wall 61 illustrated in FIG. 5 and an outer peripheral wall 62. The outer peripheral wall 62 extends both upward and downward from the peripheral edge of the support wall 61.

The upper cover 50 is assembled with the lower cover 60 by engaging the outer peripheral wall 52 with the outer peripheral wall 62 from above. The outer peripheral wall 52 and the outer peripheral wall 62 assembled in this way configure the outer peripheral wall 130. Here, “engaging the outer peripheral wall 52 with the outer peripheral wall 62” signifies that one or more protrusions provided on one of the outer peripheral wall 52 and the outer peripheral wall 62 are respectively fitted in one or more recesses formed in the other of the outer peripheral wall 52 and the outer peripheral wall 62, or that one or more hooks provided on one of the outer peripheral wall 52 and the outer peripheral wall 62 are respectively hooked in one or more engagement holes formed in the other of the outer peripheral wall 52 and the outer peripheral wall 62.

Next, the lower case 40 will be described with reference to FIGS. 4 through 10. As illustrated in FIGS. 4 through 6, the lower case 40 includes a lower wall 71, an intermediate wall 81, an outer peripheral wall 140, a head peripheral wall 83, and a partitioning wall 88. The lower wall 71 constitutes a lower edge of the lower case 40. The lower wall 71 extends in both the front-rear direction and the left-right direction, and has a rectangular shape in a plan view. A front edge of the lower wall 71 configures a lower wall of the arm portion 49. As illustrated in FIG. 5, the intermediate wall 81 is arranged further upward relative to the lower wall 71 and constitutes an upper edge of the lower case 40. The intermediate wall 81 extends in both the front-rear direction and the left-right direction, and has a rectangular shape in a plan view. A front edge of the intermediate wall 81 configures an upper wall of the arm portion 49. The lower wall 71 and the intermediate wall 81 are arranged in the up-down direction.

The outer peripheral wall 140 extends from a peripheral edge of the lower wall 71 to a peripheral edge of the intermediate wall 81. That is, the outer peripheral wall 140 extends between the lower wall 71 and the intermediate wall 81. The outer peripheral wall 140 includes a front wall 141, a rear wall 142, a left wall 143, and a right wall 144. The front wall 141 constitutes a front edge of the lower case 40, and extends in both the left-right direction and the up-down direction. A right edge of the front wall 141 is in the approximate center of the lower case 40 in the left-right direction. The front wall 141 configures a front wall of the arm portion 49. The rear wall 142 constitutes a rear edge the lower case 40, and extends in both the left-right direction and the up-down direction. The front wall 141 and the rear wall 142 are arrange in the front-rear direction.

The left wall 143 constitutes a left edge of the lower case 40, and extends in both the front-rear direction and the up-down direction. A front edge of the left wall 143 is connected to a left edge of the front wall 141. A rear edge of the left wall 143 is connected to a left edge of the rear wall 142. The right wall 144 constitutes a right edge of the lower case 40, and extends in both the front-rear direction and the up-down direction. The left wall 143 and the right wall 144 are arranged in the left-right direction. A rear edge of the right wall 144 is connected to a right edge of the rear wall 142.

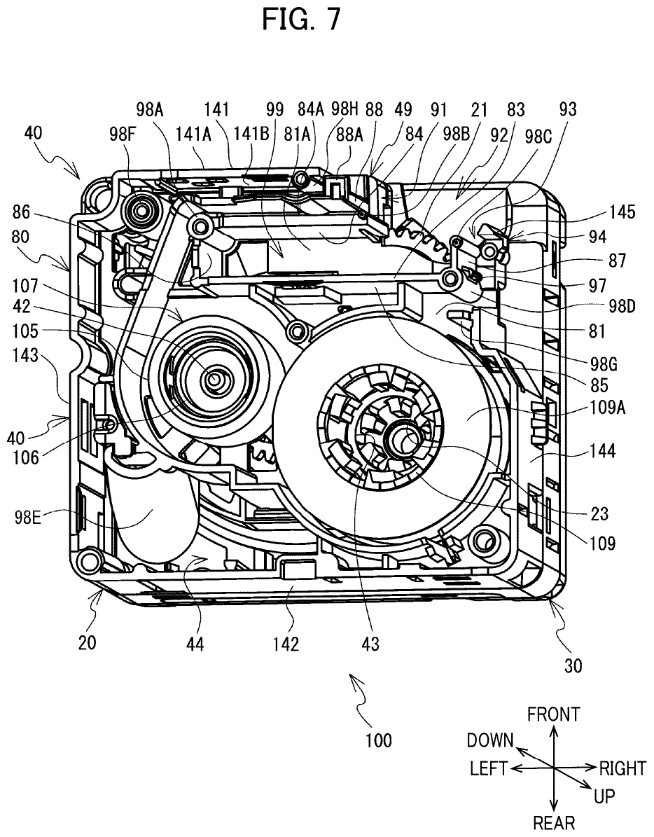

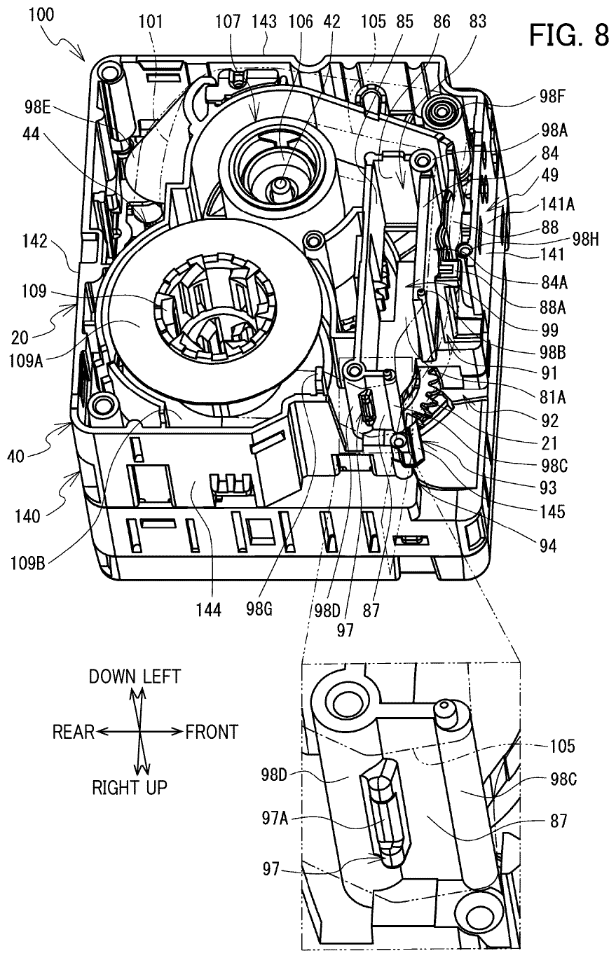

As illustrated in FIGS. 7 and 8, the head peripheral wall 83 extends downward from a front-right portion of the intermediate wall 81. An upper edge of the head peripheral wall 83 is connected to the intermediate wall 81. The head peripheral wall 83 surrounds the head opening 99. Specifically, the head peripheral wall 83 includes a head front peripheral wall 84, a head rear peripheral wall 85, a head left peripheral wall 86, and a head right peripheral wall 87.

Each of the head front peripheral wall 84 and the head rear peripheral wall 85 extends in both the left-right direction and the up-down direction, and is arranged between the front wall 141 and the rear wall 142. The head front peripheral wall 84 and the head rear peripheral wall 85 are arranged from front to rear in this order. That is, the head rear peripheral wall 85 is positioned further rearward relative to the head front peripheral wall 84. The head front peripheral wall 84 configures a rear wall of the arm portion 49.

Each of the head left peripheral wall 86 and the head right peripheral wall 87 extends in both the front-rear direction and the up-down direction, and is arranged between the left wall 143 and the right wall 144. The head left peripheral wall 86 and the head right peripheral wall 87 are arranged from left to right in this order. That is, the head right peripheral wall 87 is positioned further rightward relative to the head left peripheral wall 86.

A right edge of the head front peripheral wall 84 is located at approximately the same position in the left-right direction as the right edge of the front wall 141. A left edge of the head front peripheral wall 84 is positioned further rightward relative to the left wall 143. A right edge of the head rear peripheral wall 85 is positioned further leftward relative to the right wall 144. A left edge of the head rear peripheral wall 85 is located at the same position in the left-right direction as the left edge of the head front peripheral wall 84. A front edge of the head left peripheral wall 86 is connected to the left edge of the head front peripheral wall 84. A rear edge of the head left peripheral wall 86 is connected to the left edge of the head rear peripheral wall 85. A rear edge of the head right peripheral wall 87 is connected to the right edge of the head rear peripheral wall 85. A front edge of the head right peripheral wall 87 is positioned further rearward relative to the front wall 141.

A length of the head front peripheral wall 84 in the left-right direction is smaller than a length of the head rear peripheral wall 85 in the left-right direction. Lengths of the head left peripheral wall 86 and the head right peripheral wall 87 in the front-rear direction are smaller than the length of the head rear peripheral wall 85 in the left-right direction and smaller than the length of the head front peripheral wall 84 in the left-right direction.

The head front peripheral wall 84 includes path-defining parts 98A and 98B, and a main portion 84A. The path-defining part 98A is provided on the left edge of the head front peripheral wall 84. The path-defining part 98A is a solid cylindrical member extending in the up-down direction and has a pin shape. During the conveyance of the ink ribbon 105, the ink ribbon 105 contacts the path-defining part 98A in an entirety of the width (in an entirety of a dimension in the up-down direction) of the ink ribbon 105 to have a contact portion with the path-defining part 98A, whereby a direction of a path of the ink ribbon 105 is changed. Specifically, the path of the ink ribbon 105 curves around an outer circumference of the path-defining part 98A. The contact portion between the ink ribbon 105 and the path-defining part 98A has a straight-line shape extending in the up-down direction when viewed in a longitudinal direction of the ink ribbon 105.

The path-defining part 98B is provided on the right edge of the head front peripheral wall 84. The path-defining part 98B is a solid cylindrical member that extends in the up-down direction and has a pin shape. During the conveyance of the ink ribbon 105, the ink ribbon 105 contacts the path-defining part 98B in an entirety of the width (in an entirety of a dimension in the up-down direction) of the ink ribbon 105 to have a contact portion with the path-defining part 98B, whereby a direction of the path of the ink ribbon 105 is changed. Specifically, the path of the ink ribbon 105 curves around an outer circumference of the path-defining part 98B. The contact portion between the ink ribbon 105 and the path-defining part 98B has a straight-line shape that extends in the up-down direction when viewed in the longitudinal direction of the ink ribbon 105.

The main portion 84A is a portion of the head front peripheral wall 84 other than both the path-defining part 98A and the path-defining part 98B. That is, the main portion 84A is a portion of the head front peripheral wall 84 between the path-defining part 98A and the path-defining part 98B. The main portion 84A has a plate shape and extends in both the left-right direction and the up-down direction. The outer circumferences of the path-defining part 98A and the path-defining part 98B protrude frontward from the main portion 84A.

The partitioning wall 88 extends in both the left-right direction and the up-down direction, and is arranged between the front wall 141 and the head front peripheral wall 84. An upper edge of the partitioning wall 88 is connected to the intermediate wall 81. A right edge of the partitioning wall 88 is located at approximately the same position in the left-right direction as the right edge of the head front peripheral wall 84. The partitioning wall 88 partitions a space between the front wall 141 and the head front peripheral wall 84 into a path for the ink ribbon 105 and a path for the printing tape 101. Specifically, a space between the partitioning wall 88 and the head front peripheral wall 84 is the path for the ink ribbon 105, and a space between the partitioning wall 88 and the front wall 141 is the path for the printing tape 101.

The intermediate wall 81 includes an upper bridging portion 81A. The upper bridging portion 81A is a portion of the intermediate wall 81 spanning between an upper edge of the head front peripheral wall 84 and an upper edge of the head rear peripheral wall 85 in the front-rear direction. That is, the upper bridging portion 81A connects the upper edge of the head front peripheral wall 84 and the upper edge of the head rear peripheral wall 85 to each other in the front-rear direction. Therefore, even if a force directed frontward were to act on the head front peripheral wall 84, for example, the upper bridging portion 81A would not contract substantially in the front-rear direction, thereby restraining the upper edge of the head front peripheral wall 84 from approaching the head rear peripheral wall 85 substantially in the front-rear direction.

As illustrated in FIGS. 5 through 8, a support shaft 42 and an upper support portion 43 are provided on the intermediate wall 81. Also, the tape insertion opening 44 (see FIGS. 7 and 8) is formed in the intermediate wall 81. The support shaft 42 is disposed on a left portion of the intermediate wall 81 and protrudes downward from a lower surface of the intermediate wall 81. The support shaft 42 supports the ribbon roll 107. Thus, the ribbon roll 107 is disposed between the head rear peripheral wall 85 and the rear wall 142 and between the left wall 143 and the right wall 144 (specifically, between head right peripheral wall 87 and the right wall 144). The ribbon roll 107 is rotatable about an axis AX1 (see FIG. 5). The axis AX1 extends in the up-down direction and passes through the center of the support shaft 42.

The upper support portion 43 is formed on the intermediate wall 81 at a position rightward of the support shaft 42. The upper support portion 43 is an outer circumferential wall having an annular shape and protrudes slightly downward from the intermediate wall 81. The upper support portion 43 is fitted in the take-up spool 109 from above. In other words, the upper support portion 43 is disposed inside an inner circumference of the take-up spool 109 in a radial direction of the take-up spool 109. The upper support portion 43 supports an upper end of the take-up spool 109 so that the take-up spool 109 is rotatable. A shaft insertion hole that penetrates the intermediate wall 81 in the up-down direction is provided on an inner side of the upper support portion 43.

As illustrated in FIGS. 7 and 8, the tape insertion opening 44 is formed in a left-rear corner of the intermediate wall 81. The tape insertion opening 44 is an opening that penetrates the intermediate wall 81 in the up-down direction. The printing tape 101 is configured to be inserted into the lower case 40 through the tape insertion opening 44 from above.

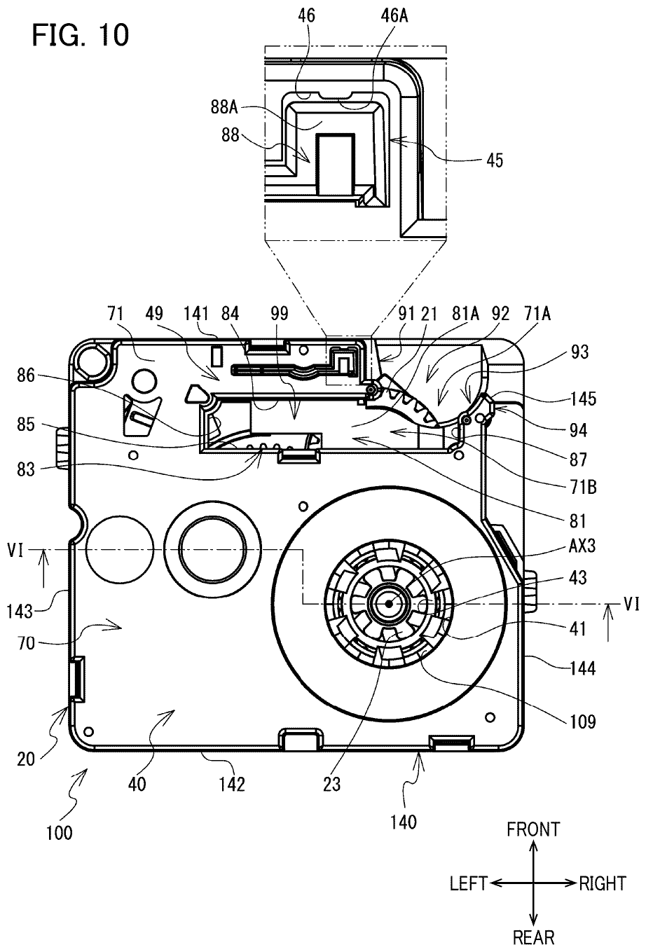

As illustrated in FIGS. 9 and 10, a first notch 71A and a second notch 71B are formed in the lower wall 71. The first notch 71A extends rearward from a right-front corner of the lower wall 71. Specifically, the first notch 71A is cut out rearward from a portion of the front edge of the lower wall 71 that is further rightward relative the right edge of the front wall 141 to a portion between the head front peripheral wall 84 and the head rear peripheral wall 85 in the front-rear direction. The second notch 71B extends leftward from a rear end of the first notch 71A. Specifically, the second notch 71B is formed continuously with the first notch 71A and is cut out in the left-right direction between the head front peripheral wall 84 and the head rear peripheral wall 85.

An edge of the lower wall 71 forming a left edge of the first notch 71A defines a lower edge of a guide opening 91 (described later). An edge of the lower wall 71 forming a right edge of the first notch 71A is connected to a lower edge of the head right peripheral wall 87. An edge of the lower wall 71 forming a front edge of the second notch 71B is connected to a lower edge of the head front peripheral wall 84. An edge of the lower wall 71 forming a rear edge of the second notch 71B is connected to a lower edge of the head rear peripheral wall 85. An edge of the lower wall 71 forming a left edge of the second notch 71B is connected to a lower edge of the head left peripheral wall 86. Accordingly, the first notch 71A and the second notch 71B constitute a lower end of the head opening 99.

A lower support portion 41 and the support shaft 48 (see FIG. 9) are provided on the lower wall 71. The lower support portion 41 is provided in a right-rear portion of the lower wall 71. The lower support portion 41 is an inner circumferential wall defining a support hole that penetrates the lower wall 71 in the up-down direction.

As illustrated in FIG. 6, the take-up spool 109 is fitted in the lower support portion 41. That is, the lower support portion 41 is disposed outside an outer circumference of the take-up spool 109 in the radial direction of the take-up spool 109. The lower support portion 41 supports a lower end of the take-up spool 109 so that the take-up spool 109 is rotatable. In other words, the take-up spool 109 is supported from above by the upper support portion 43 and from below by the lower support portion 41. The take-up spool 109 is rotatable about an axis AX3 (see FIGS. 5 and 10). The axis AX3 extends in the up-down direction and passes through centers of the lower support portion 41 and the upper support portion 43. The axis AX3 is a diametrical center of the take-up spool 109 in a plan view. The take-up spool 109 is arranged between the head rear peripheral wall 85 and the rear wall 142 and between the left wall 143 and the right wall 144 (specifically, between head right peripheral wall 87 and the right wall 144).

In the radial direction of the take-up spool 109, a first gap G1 is formed between the lower end of the take-up spool 109 and the lower support portion 41, and a second gap G2 is formed between the upper end of the take-up spool 109 and the upper support portion 43, as illustrated in FIG. 6. In other words, the take-up spool 109 is supported by the lower support portion 41 with the first gap G1 present between the lower end of the take-up spool 109 and the lower support portion 41 in the radial direction, and is supported by the upper support portion 43 with the second gap G2 present between the upper end of the take-up spool 109 and the upper support portion 43 in the radial direction.

The first gap G1 has a size that is equivalent to a radius of the outer diameter R11 at the lower end of the take-up spool 109 minus a radius of an inner diameter of the lower support portion 41. While not limited to any specific size, the first gap G1 is approximately 0.3 mm in the present embodiment. The second gap G2 has a size that is equivalent to a radius of an outer diameter of the upper support portion 43 minus a radius of the inner diameter R12 at the upper end of the take-up spool 109. While not limited to any specific size, the second gap G2 is approximately 0.06 mm in the present embodiment.

That is, the first gap G1 is different in size from the second gap G2, and is greater than the second gap G2 in the present embodiment. An absolute value of the difference between the first gap G1 and the second gap G2 (|G1−G2|) is less than a thickness T3 of the lower support portion 41 in the up-down direction and is less than a thickness T4 of the upper support portion 43 in the up-down direction. In the present embodiment, the absolute value of the difference between the first gap G1 and the second gap G2 is approximately 0.24 mm.

As illustrated in FIG. 9, the support shaft 48 is located diagonally leftward and frontward of the lower support portion 41, and protrudes upward from an upper surface of the lower wall 71. The support shaft 48 opposes the support shaft 31 in the up-down direction (see FIG. 5). The support shaft 48 supports the tape roll 103.

As illustrated in FIGS. 9 and 10, the lower wall 71 includes an opening edge 46. The opening edge 46 is provided in a portion of the lower wall 71 that is further frontward relative to the second notch 71B, i.e., in the arm portion 49. The opening edge 46 has a rectangular shape whose dimension in the left-right direction is greater than that in the front-rear direction, and defines an engagement hole 45. The engagement hole 45 penetrates the lower wall 71 in the up-down direction and is elongated in the left-right direction. A lower end 88A of the partitioning wall 88 is fitted in the engagement hole 45 (see FIG. 10).

The lower wall 71 includes a rib 46A. The rib 46A is disposed in a portion of the opening edge 46A defining a right edge of the engagement hole 45. Specifically, the rib 46A protrudes rearward from a front edge of the opening edge 46, i.e., into the engagement hole 45. In other words, the rib 46A protrudes in the front-rear direction from the opening edge 46 toward the lower end 88A of the partitioning wall 88. The rib 46A has a rear edge that is either slightly separated from a front edge of the lower end 88A of the partitioning wall 88 or contacts the lower end 88A of the partitioning wall 88. The rib 46A is at least positioned sufficiently close to the lower end 88A of the partitioning wall 88 so that the rear edge of the rib 46A contacts the lower end 88A of the partitioning wall 88 when a force directed rearward is applied to the arm portion 49.

As illustrated in FIGS. 4 and 5, the lower case 40 includes an upper cover 80 and a lower cover 70, and is configured by assembling the upper cover 80 with the lower cover 70 from above. The upper cover 80 constitutes an upper portion of the lower case 40. The upper cover 80 includes the intermediate wall 81, an outer peripheral wall 82, the head peripheral wall 83, and the partitioning wall 88. The outer peripheral wall 82 extends downward from the peripheral edge of the intermediate wall 81. The lower cover 70 constitutes a lower portion of the lower case 40. The lower cover 70 includes the lower wall 71, and an outer peripheral wall 72. The outer peripheral wall 72 extends upward from the peripheral edge of the lower wall 71.

The lower cover 70 is assembled with the upper cover 80 by engaging the outer peripheral wall 72 with the outer peripheral wall 82 from below. Through this assembly, the outer peripheral wall 72 and the outer peripheral wall 82 configure the outer peripheral wall 140. Here, “engaging the outer peripheral wall 72 with the outer peripheral wall 82” signifies that one or more protrusions provided on one of the outer peripheral wall 72 and the outer peripheral wall 82 are fitted in one or more recesses formed in the other of the outer peripheral wall 72 and the outer peripheral wall 82, or that one or more hooks provided on one of the outer peripheral wall 72 and the outer peripheral wall 82 are hooked in one or more engagement holes formed in the other of the outer peripheral wall 72 and the outer peripheral wall 82.

As illustrated in FIGS. 4 and 7, a guide opening 91, an exposed area 92, an entry opening 93, and a discharge opening 94 are formed in the lower case 40. The guide opening 91 is formed between the right edge of the head front peripheral wall 84 and the right edge of the front wall 141. The guide opening 91 has a slit shape that extends in the up-down direction. The guide opening 91 functions to guide the printing tape 101 and the ink ribbon 105 from the interior of the arm portion 49 into the exposed area 92, as illustrated in FIG. 4.

The exposed area 92 constitutes a right-front area of the head opening 99, and extends from a portion between the right edge of the front wall 141 and the right edge of the head front peripheral wall 84 to a portion between the front edge of the head right peripheral wall 87 and the front edge of the right wall 144. The exposed area 92 allows a portion of the printing tape 101 and the ink ribbon 105 positioned between the guide opening 91 and the discharge opening 94 to be exposed outside the lower case 40, as illustrated in FIG. 4.

The entry opening 93 is formed between the front edge of the head right peripheral wall 87 and the front edge of the right wall 144. The entry opening 93 has a slit shape that extends in the up-down direction. The entry opening 93 allows the ink ribbon 105 to enter the lower case 40 from the exposed area 92 therethrough.

The discharge opening 94 is formed in the front edge of the right wall 144. The discharge opening 94 has a slit shape that extends in the up-down direction. The discharge opening 94 allows the printing tape 101 to be discharged from the lower case 40 therethrough. The discharge opening 94 is defined by a guide 145 at the front edge of the right wall 144. The guide 145 has a solid cylindrical shape that is elongated in the up-down direction.

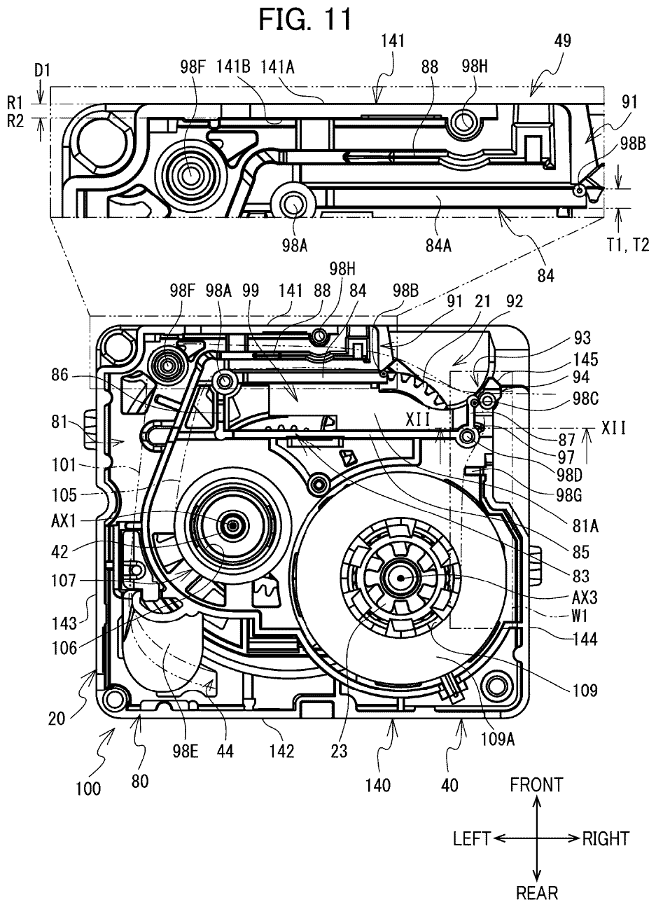

Next, a relationship between thicknesses of the main portion 84A and the front wall 141 in the front-rear direction will be described with reference to FIG. 11. First, a front surface area and a rear surface area will be defined.

The front wall 141 has a front surface 141A, and a rear surface 141B. The front surface 141A is a surface of the front wall 141 that faces frontward. The rear surface 141B is a surface of the front wall 141 that faces rearward. The front surface 141A may include a plurality of surfaces having different positions in the front-rear direction, for example. Specifically, the front surface 141A may include recessed portions or protruding portions. A front surface area is an area of the front surface 141A within which all points in the front-rear direction fall in the same plane.

For example, only a single front surface area is present if the entire front surface 141A is flush, but multiple front surface areas exists when the front surface 141A has recessed portions or protruding portions. Specifically, if the front surface 141A has both a recessed portion and a protruding portion, three surfaces serve as the front surface areas, i.e., a surface on a protruding end of the protruding portion, a surface in a bottom of the recessed portion, and a surface from which the protruding portion protrudes and in which an opening to the recessed portion is formed. The front surface 141A includes a maximum front surface area. This maximum front surface area is the front surface area that occupies the largest amount of area within the front surface 141A.

Next, the maximum front surface area will be described for one case. This case assumes that the front surface 141A of the front wall 141 possesses one or more recessed portions and one or more protruding portions; a total area of the front surface area occupied by protruding ends of the one or more protruding portions is smaller than a total area of the front surface area occupied by a surface from which the protruding portions protrude and in which openings to the recessed portions are formed; and a total area of the front surface area occupied by bottom surfaces in the one or more recessed portions is smaller than the total area of the front surface area occupied by the surface from which the protruding portions protrude and in which the openings to the recessed portions are formed.

In this case, the front surface area occupied by the surface from which the protruding portions protrude and in which the openings to the recessed portions are formed is the front surface area occupying the greatest amount of area within the front surface 141A and, hence, the maximum front surface area. FIG. 11 indicates a position of the maximum front surface area in the front-rear direction with a virtual line R1.

Similar to the front surface area, a rear surface area is an area of the rear surface 141B within which all points in the front-rear direction fall in the same plane. The rear surface 141B includes a maximum rear surface area. This maximum rear surface area is the rear surface area that occupies the largest amount of area within the rear surface 141B. For example, the maximum rear surface area is an area of the rear surface 141B excluding a path-defining part 98H (described later). FIG. 11 indicates a position of the maximum rear surface area in the front-rear direction with a virtual line R2.

The thickest portion of the main portion 84A in the front-rear direction will be referred to as “maximum thickness T1 of the main portion 84A”. While not limited to any specific size, the maximum thickness T1 of the main portion 84A is 1.7 mm, for example. The maximum thickness T1 of the main portion 84A in the front-rear direction is greater than a distance D1 in the front-rear direction between the maximum front surface area and the maximum rear surface area. While not limited to any specific size, the distance D1 in the front-rear direction is 1.0 mm, for example.

The thinnest portion of the main portion 84A in the front-rear direction will be referred to as “minimum thickness T2 of the main portion 84A”. While not limited to any specific size, the minimum thickness T2 of the main portion 84A is 1.7 mm, for example, which is the same as the maximum thickness T1 in the cassette 100. In other words, the main portion 84A in the cassette 100 of the present embodiment is a flat plate with uniform thickness. Thus, the minimum thickness T2 of the main portion 84A in the front-rear direction is greater than the distance D1 in the front-rear direction between the maximum front surface area and the maximum rear surface area.

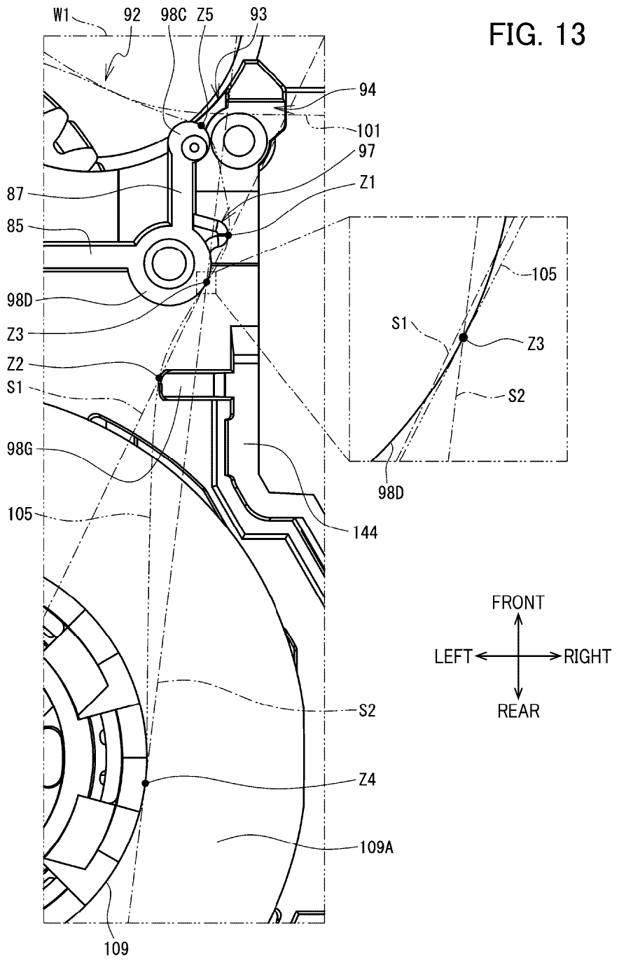

Next, the paths of the ink ribbon 105 and the printing tape 101 will be described with reference to FIGS. 8 and 11. In addition to the path-defining parts 98A and 98B, the lower case 40 includes path-defining parts 98C, 98D, 98E, 98F, 98G, and 98H. The path-defining part 98C is provided on the front edge of the head right peripheral wall 87. The path-defining part 98C is a solid cylindrical member extending in the up-down direction and formed in a pin shape. During the conveyance of the ink ribbon 105, the ink ribbon 105 contacts the path-defining part 98C in the entirety of the width (i.e., in the entirety of the dimension in the up-down direction) of the ink ribbon 105 to have a contact portion Z5 (see FIG. 13) with the path-defining part 98C, and accordingly, the direction of the path of the ink ribbon 105 is changed. Specifically, the path of the ink ribbon 105 curves along an outer circumference of the path-defining part 98C. The contact portion Z5 between the ink ribbon 105 and the path-defining part 98C has a straight-line shape that extends in the up-down direction when viewed in the longitudinal direction of the ink ribbon 105.

The path-defining part 98D is provided on the rear edge of the head right peripheral wall 87. The path-defining part 98D is a solid cylindrical member extending in the up-down direction and formed in a pin shape. During the conveyance of the ink ribbon 105, the ink ribbon 105 contacts the path-defining part 98D in the entirety of the width (i.e., in the entirety of the dimension in the up-down direction) of the ink ribbon 105 to have a contact portion Z3 (see FIG. 13) with the path-defining part 98D, whereby the direction of the path of the ink ribbon 105 is changed. Specifically, the path of the ink ribbon 105 curves around an outer circumference of the path-defining part 98D. The contact portion Z3 between the ink ribbon 105 and the path-defining part 98D has a straight-line shape and extends in the up-down direction when viewed in the longitudinal direction of the ink ribbon 105.

The head right peripheral wall 87 includes a rib 97. The rib 97 is provided between the path-defining part 98C and the path-defining part 98D. That is, the rib 97 is provided on a portion of the head right peripheral wall 87 other than the front edge and the rear edge. The rib 97 is a protrusion that protrudes rightward from a right surface of the head right peripheral wall 87, and is elongated in the up-down direction. An upper end of the rib 97 is positioned further downward relative to an upper edge of the ink ribbon 105. A lower end of the rib 97 is positioned further upward relative to a lower edge of the ink ribbon 105. The center of the rib 97 in the up-down direction is approximately aligned with the center of the ink ribbon 105 in the up-down direction (i.e., the width direction). While not limited to any specific size, a length of the rib 97 in the up-down direction is approximately 7 mm, for example, while a width of the ink ribbon 105 in the cassette 100 is 12 mm.

A recess 97A is formed in the rib 97. The recess 97A is recessed leftward in the center of the rib 97. When the upper cover 80 is formed of resin, for example, the recess 97A allows gas generated during the injection molding process to escape.

The path-defining part 98E is provided in a left-rear portion of the lower case 40. The path-defining part 98E is a wall that protrudes downward from the intermediate wall 81. The path-defining part 98E extends frontward while extending leftward. The path-defining part 98E has a curved shape that expands rearward in the left-right center thereof. When the printing tape 101 is conveyed, the printing tape 101 contacts the path-defining part 98E so that a direction of the path of the printing tape 101 is changed. Specifically, the path of the printing tape 101 is curved along a rear surface of the path-defining part 98E.

The path-defining part 98F is provided in a left-front corner portion of the lower case 40. Specifically, the path-defining part 98F is disposed between the left edge of the head front peripheral wall 84 and the left wall 143. The path-defining part 98F is a roller extending in the up-down direction. The path-defining part 98F is rotatably supported by the lower case 40. During the conveyance of the printing tape 101, the printing tape 101 contacts the path-defining part 98F, whereby the direction of the path of the printing tape 101 is changed. Specifically, the path of the printing tape 101 is curved along an outer circumference of the path-defining part 98F.

The path-defining part 98G is provided at a position further rearward relative to the path-defining part 98D. The path-defining part 98G is a plate forming a wall structure that extends in both the up-down direction and the left-right direction. The path-defining part 98G protrudes leftward from the right wall 144. That is, the path-defining part 98G is provided on the opposite side of the path of the ink ribbon 105 from the path-defining part 98D when viewed in the up-down direction, and specifically on the right side of the path in the present embodiment. During the conveyance of the ink ribbon 105, the path-defining part 98G contacts the ink ribbon 105 in the entirety of the width (in the entirety of the dimension in the up-down direction) of the ink ribbon 105 to have a contact portion Z2 with the path-defining part 98G, thereby changing the direction of the path of the ink ribbon 105. Specifically, the path of the ink ribbon 105 is curved along a left edge of the path-defining part 98G. The contact portion Z2 between the ink ribbon 105 and the path-defining part 98G has a straight-line shape and extends in the up-down direction when viewed in the longitudinal direction of the ink ribbon 105. Note that the contact portion Z2 between the ink ribbon 105 and the path-defining part 98G is positioned downstream of contact portion Z3 between the ink ribbon 105 and the path-defining part 98D in a conveying direction in which the ink ribbon 105 is conveyed.

The path-defining part 98H is provided on the rear surface 141B of the front wall 141. The path-defining part 98H is a solid cylindrical member extending in the up-down direction and is formed in a pin shape. When the printing tape 101 is conveyed, the path-defining part 98H contacts the printing tape 101 to change the direction of the path of the printing tape 101. Specifically, the path of the printing tape 101 is curved along an outer circumference of the path-defining part 98H.

The path of the ink ribbon 105 is defined by the path-defining parts 98A, 98B, 98C, 98D, and 98G. That is, the ink ribbon 105 extends frontward from the left side on an outer circumference of the ribbon roll 107 to the path-defining part 98A while passing through a portion between the left wall 143 and the head left peripheral wall 86. The ink ribbon 105 is curved rightward along the outer circumference of the path-defining part 98A and passes into the arm portion 49. Within the arm portion 49, the ink ribbon 105 passes through a portion between the front wall 141 and the head front peripheral wall 84, and specifically between the partitioning wall 88 and the head front peripheral wall 84, and extends to the path-defining part 98B.

Since the outer circumferences of the path-defining part 98A and the path-defining part 98B protrude frontward from the main portion 84A, the ink ribbon 105 passes through the arm portion 49 at a position separated from and further frontward relative to the main portion 84A and, hence, does not contact the main portion 84A.

The ink ribbon 105 is guided into the exposed area 92 through the guide opening 91 while being curved diagonally rightward and rearward along the outer circumference of the path-defining part 98B, and extends to the path-defining part 98C. The ink ribbon 105 then re-enters the lower case 40 through the entry opening 93 while being curved rearward along the outer circumference of the path-defining part 98C. From the path-defining part 98C, the ink ribbon 105 extends rearward to pass through a portion between the head right peripheral wall 87 and the right wall 144, and extends to the path-defining part 98D.

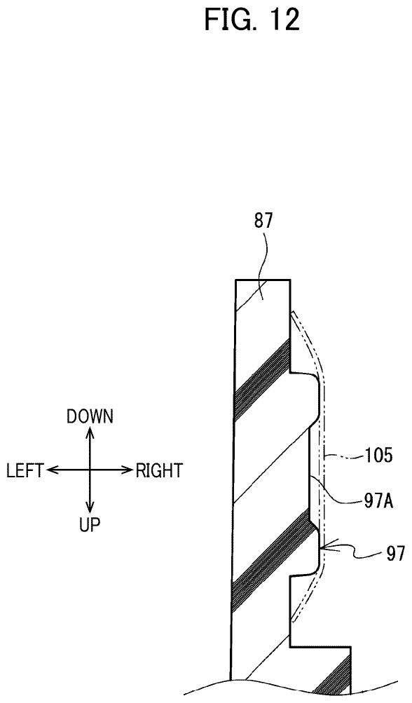

The ink ribbon 105 contacts the rib 97 at a position between the path-defining part 98C and the path-defining part 98D to have a contact portion Z1 with the rib 97. At this time, the rib 97 contacts the widthwise center portion of the ink ribbon 105 (the center portion of the ink ribbon 105 in the width direction, i.e., in the up-down direction) at the contact portion Z1 but does not contact either widthwise edge (either edge in the widthwise direction), as illustrated in FIG. 12. Therefore, the rib 97 causes the ink ribbon 105 to be curved along the width of the ink ribbon 105 with both the widthwise edges (upper and lower edges) of the ink ribbon 105 curled leftward, i.e., with the widthwise center portion of the ink ribbon 105 protruding rightward. This shape of the ink ribbon 105 suppresses skewing of the ink ribbon 105. Note that skewing of the ink ribbon 105 is a phenomenon in which the ink ribbon 105 progresses along a direction not orthogonal to the axis AX1 (i.e., the up-down direction). Directions that are not orthogonal to the axis AX1 include direction sloping downward as extending rightward and direction sloping downward as extending rearward.

In the present embodiment, the path-defining part 98C is present between the exposed area 92 and the rib 97. Therefore, even when the ink ribbon 105 formed in a curve along the width direction by the rib 97, the ink ribbon 105 is returned to its uncurved state by the path-defining part 98C. Accordingly, this arrangement suppresses curling of the ink ribbon 105 in the width direction produced by the rib 97 from adversely affecting printing by the thermal head 4 in the exposed area 92.

As illustrated in FIGS. 8 and 11, the ink ribbon 105 is curved rearward and slightly leftward along the outer circumference of the path-defining part 98D and extends to the path-defining part 98G. The ink ribbon 105 is then curved rearward and slightly rightward along the left edge of the path-defining part 98G and crosses over to the right edge on the circumference of the take-up spool 109. In other words, the ink ribbon 105 passes from the ribbon roll 107 sequentially over the path-defining part 98A, the path-defining part 98B, the path-defining part 98C, the path-defining part 98D, and the path-defining part 98G and extends to the take-up spool 109.

The take-up spool 109 rotates in a clockwise direction in a bottom view to take up the ink ribbon 105. Hence, after passing through a portion between the head right peripheral wall 87 and the right wall 144, the ink ribbon 105 is maintained between the center of the take-up spool 109 and the right wall 144 in the left-right direction while being taken up by the take-up spool 109.

Note that, in a case where the take-up spool 109 is configured to take up the ink ribbon 105 by rotating in a counterclockwise direction in a bottom view, the ink ribbon 105 would cross over to the left edge on the outer circumference of the take-up spool 109 after passing through a portion between the head right peripheral wall 87 and the right wall 144. For this reason, after passing through a portion between the head right peripheral wall 87 and the right wall 144, the ink ribbon 105 is taken up by the take-up spool 109 by crossing from right to left through a portion between the center of the take-up spool 109 and the path-defining part 98D.

In other words, the lower case 40 defines the path along which the ink ribbon 105 is conveyed in the conveying direction when the take-up spool 109 takes up the ink ribbon 105 from the ribbon roll 107. The path of the ink ribbon 105 includes a first part, a second part, the exposed area 92, a third part, and a fourth part from an upstream side in the conveying direction. The first part passes between the left wall 143 and the head left peripheral wall 86. The second part passes between the front wall 141 and the head front peripheral wall 84. The third part passes between the head right peripheral wall 87 and the right wall 144. The fourth part passes between the right wall 144 and the center of the take-up spool 109.

The path for the printing tape 101 is defined by the path-defining parts 98E, 98F, and 98H. That is, the printing tape 101 extends diagonally downward and leftward from a rear edge on an outer circumference of the tape roll 103, is inserted sequentially through the tape guide slit (not illustrated) and the tape insertion opening 44, and extends to the path-defining part 98E. The printing tape 101 is then curved frontward along an outer circumference of the path-defining part 98E, passes through a portion between the left wall 143 and the head left peripheral wall 86, and extends to the path-defining part 98F. The printing tape 101 is curved rightward along an outer circumference of the path-defining part 98F and passes into the arm portion 49.

Within the arm portion 49, the printing tape 101 extends from left to right while curving slightly frontward along an outer circumference of the path-defining part 98H. While in the arm portion 49, the printing tape 101 passes through a portion between the front wall 141 and the head front peripheral wall 84, and more specifically between the front wall 141 and the partitioning wall 88, and extends to the guide opening 91. The printing tape 101 is guided into the exposed area 92 through the guide opening 91.

In the exposed area 92, the ink ribbon 105 is superimposed with the printing tape 101 from rearward. The printing tape 101 then extends from the exposed area 92 to the discharge opening 94 and is discharged from the case 20 through the discharge opening 94. In other words, the printing tape 101 passes sequentially from the tape roll 103 over the path-defining part 98E, the path-defining part 98F, and the path-defining part 98H and is discharged through the discharge opening 94.

In other words, the lower case 40 further defines the path along which the printing tape 101 is conveyed in a conveying direction of the printing tape 101. The path of the printing tape 101 includes the tape insertion opening 44, a first part, a second part, and the exposed area 92 from an upstream side in the conveying direction of the printing tape 101. The first part of the path for the printing tape 101 passes between the left wall 143 and the head left peripheral wall 86. The second part of the path for the printing tape 101 passes between the front wall 141 and the head front peripheral wall 84.

Here, positional relationships among the take-up spool 109, the path-defining parts 98D and 98G, and the rib 97 will be described in greater detail with reference to FIG. 13. A virtual line S1 in FIG. 13 is a straight line that passes through both the contact portion Z1 between the rib 97 and the ink ribbon 105 and the contact portion Z2 between the path-defining part 98G and the ink ribbon 105 when viewed in the up-down direction. Among a pair of straight lines tangential to the outer circumferential surface of the take-up spool 109 and passing through the contact portion Z3 between the path-defining part 98D and the ink ribbon 105, a virtual line S2 denotes the straight line passing through the right side of the take-up spool 109. That is, the virtual line S2 denotes the straight line passing through the contact portion Z3 between the path-defining par 98D and the ink ribbon 105 and tangential to the outer circumferential surface of the take-up spool 109 at a position rightward of the center of the take-up spool 109. The virtual line S2 passes through a point Z4 on the outer circumferential surface of the take-up spool 109. That is, the point Z4 is the point of tangency between the virtual line S2 and the outer circumferential surface of the take-up spool 109 and is positioned rightward relative to the center of the take-up spool 109.

When viewed in the up-down direction, the virtual line S1 passes through a point positioned to the left of the contact portion Z3 between the path-defining part 98D and the ink ribbon 105. In other words, the contact portion Z3 between the path-defining part 98D and the ink ribbon 105 is positioned on the right side of the virtual line S1. When viewed in the up-down direction, the virtual line S2 passes through a point positioned to the right of the contact portion Z2 between the path-defining part 98G and the ink ribbon 105. In other words, the contact portion Z2 between the path-defining part 98G and the ink ribbon 105 is positioned to the left of the virtual line S2.

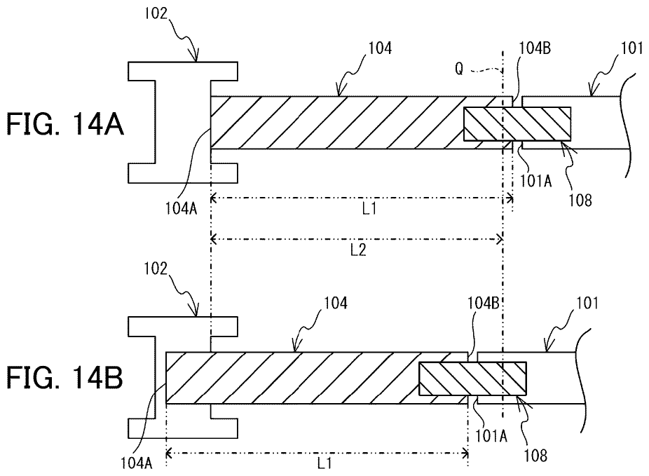

Next, a method of fixing the printing tape 101 to the tape spool 102 will be described with reference to FIGS. 14A and 14B. The printing tape 101 is fixed to the tape spool 102 via an anchoring tape 104. Specifically, the anchoring tape 104 has a proximal end 104A and a distal end 104B. The proximal end 104A is fixed to an outer circumferential surface of the tape spool 102. The distal end 104B of the anchoring tape 104 is attached to a proximal end 101A of the printing tape 101 via an adhesive tape 108. The anchoring tape 104 and the adhesive tape 108 do not constitute the printing medium.

The anchoring tape 104 and the adhesive tape 108 have colors that allow the user to recognize the presence of the anchoring tape 104 and the adhesive tape 108 and to recognize that the anchoring tape 104 and the adhesive tape 108 are different from the printing tape 101. For example, the anchoring tape 104 has a pattern such as zebra stripes or other colors that are different from a color of the printing tape 101. The adhesive tape 108 also has a different color from the color of the printing tape 101 and is not colorless and transparent. For example, the adhesive tape 108 is red. The color and pattern of the adhesive tape 108 may be the same as or different from the color and pattern of the anchoring tape 104.

A virtual line Q in FIGS. 14A and 14B indicates a position of the guide opening 91 relative to the tape spool 102. A length L1 of the anchoring tape 104 in the longitudinal direction is approximately equivalent to a distance L2 from the tape spool 102 to the guide opening 91 (the virtual line Q) along the conveying path of the printing tape 101. When all of the printing tape 101 has been drawn off the tape spool 102, the distal end 104B of the anchoring tape 104 is exposed outside through the guide opening 91, as illustrated in FIG. 14A. That is, the distal end 104B of the anchoring tape 104 is positioned further rightward relative to the virtual line Q. At this time, the user can recognize that the cassette 100 has run out of the printing tape 101.

As illustrated in FIG. 14B, the distal end 104B of the anchoring tape 104 may not reach the guide opening 91 while the anchoring tape 104 has not been completely drawn off the tape spool 102, for example. In other words, the distal end 104B of the anchoring tape 104 may be positioned further leftward relative to the virtual line Q at this time. In such cases, if the adhesive tape 108 were colorless and transparent, the user would have difficulty seeing either of the anchoring tape 104 and the adhesive tape 108. Therefore, it would be difficult for the user to recognize that the cassette 100 has run out of printing tape 101.

With the cassette 100 according to the present embodiment, the user can recognize that the cassette 100 has run out of the printing tape 101 once the adhesive tape 108 has reached the guide opening 91, even if the distal end 104B of the anchoring tape 104 has not arrived at the guide opening 91. The length L1 of the anchoring tape 104 may be difficult to modify due to design, manufacturing, or other concerns. Thus, by utilizing the adhesive tape 108, the cassette 100 of the first embodiment helps let the user know when the cassette 100 has run out of the printing tape 101 without having to adjust the length L1 of the anchoring tape 104.

Next, printing operations on the printer 1 will be described with reference to FIGS. 1 through 3. While the cover 3 illustrated in FIG. 1 is removed from the housing 2, as illustrated in FIGS. 1 and 2, the user attaches the cassette 100 to the attachment portion 11 from above so that the rotational shaft 6 is inserted into the lower support portion 41 (see FIG. 4) and the thermal head 4 is inserted into the head opening 99. The user then attaches the cover 3 to the housing 2, whereby a cam (not illustrated) causes the right end of the platen holder 15 to be pivotally moved rearward about the pivot shaft 16 from a position in which the platen holder 15 is urged frontward by the spring (not illustrated). At this time, the platen roller 18 illustrated in FIG. 1 presses the ink ribbon 105 and the printing tape 101 in their overlapped state against the thermal head 4 from frontward. Additionally, the platen gear 19 is brought into meshing engagement with the output gear 21.

The user inputs a print instruction into the printer 1 through an operation unit (not illustrated). The printer 1 drives the conveying motor to rotate the rotational shaft 6, whereby the rotational shaft 6 rotates the take-up spool 109 and the input gear 23. The rotation of the take-up spool 109 conveys the ink ribbon 105 from the ribbon roll 107 toward the take-up spool 109. The rotation of the input gear 23 rotates the output gear 21 via the coupling gear 22. The rotation of the output gear 21 rotates both the platen gear 19 and the platen roller 18.

By rotating in the clockwise direction in a plan view, the platen roller 18 draws the printing tape 101 off the tape roll 103 and conveys the printing tape 101 rightward. Hence, the left side of the printer 1 is upstream in the conveying direction of the printing tape 101 while the right side of the printer 1 is downstream in the conveying direction of the printing tape 101. The thermal head 4 selectively heats a plurality of heating elements, resulting in ink in the ink ribbon 105 being thermally transferred onto the printing tape 101 at positions corresponding to the heated heating elements.

The printer 1 performs printing on the printing tape 101 in the exposed area 92 by repeatedly performing the conveyance of the printing tape 101 with the platen roller 18 and selectively heating of the plurality of heating elements with the thermal head 4. The printed printing tape 101 is discharged from the lower case 40 through the discharge opening 94 and then discharged from the housing 2 through the discharge opening 12.

In the first embodiment described above, the maximum thickness T1 of the main portion 84A in the front-rear direction is greater than the distance D1 between the maximum front surface area and the maximum rear surface area in the front-rear direction. Accordingly, the head front peripheral wall 84 can be made more rigid than a configuration in which the maximum thickness T1 of the main portion 84A in the front-rear direction is smaller than or equal to the distance D1 between the maximum front surface area and the maximum rear surface area in the front-rear direction. This configuration reduces the likelihood that the lower edge of the head front peripheral wall 84 is bent rearward relative to the upper edge of the head front peripheral wall 84. Therefore, the cassette 100 can help suppress skewing of the ink ribbon 105.

In the first embodiment, the minimum thickness T2 of the main portion 84A in the front-rear direction is greater than the distance D1 between the maximum front surface area and maximum rear surface area in the front-rear direction, thereby further enhancing the rigidity of the main portion 84A. Accordingly, the cassette 100 can better restrain skewing of the ink ribbon 105.

In the first embodiment, the tape insertion opening 44 is formed in the intermediate wall 81. With this arrangement, the user can more easily handle the printing tape 101 than a configuration in which the printing tape 101 is handled separately from the lower case 40. Accordingly, the cassette 100 can help facilitate handling of the printing tape 101.

In the first embodiment, the cassette 100 includes the upper case 30. The user can handle the printing tape 101 without touching the same. Accordingly, the cassette 100 can help facilitate handling of the printing tape 101.

In the first embodiment, the rib 46A protrudes rearward from the opening edge 46. Therefore, when a force in a direction for bending the lower edge of the head front peripheral wall 84 rearward relative to the upper edge of the head front peripheral wall 84 is applied to the lower wall 71, the rib 46A contacts the lower end 88A of the partitioning wall 88. At this time, the force in the direction for bending the lower edge of the head front peripheral wall 84 rearward relative to the upper edge of the head front peripheral wall 84 is distributed from the lower wall 71 to the partitioning wall 88 via the rib 46A. This action restrains the lower edge of the head front peripheral wall 84 from bending rearward relative to the upper edge of the head front peripheral wall 84. Accordingly, the cassette 100 helps suppress skewing of the ink ribbon 105.

In the first embodiment, the rib 97 protrudes rightward from a portion of the head right peripheral wall 87 excluding the front edge and the rear edge. The rib 97 contacts the widthwise center of the ink ribbon 105, thereby forming a curve in the ink ribbon 105 along the width direction. By employing the rib 97 to curl the ink ribbon 105 along the width direction in this way, any inclination of the ink ribbon 105 to deviate in the width direction applies a force to the ink ribbon 105 that suppresses such deviation. Accordingly, the cassette 100 can help suppress skewing of the ink ribbon 105.

In the first embodiment, the path-defining part 98D is provided on the rear edge of the head right peripheral wall 87. The path-defining part 98D contacts the ink ribbon 105 along the entire width thereof. This contact portion between the part-defining part 98D and the ink ribbon 105 is in a form of a straight line extending in the up-down direction when viewed in the longitudinal direction of the ink ribbon 105. Hence, after the ink ribbon 105 has been formed in a curve along the width direction by the rib 97, the path-defining part 98D returns the ink ribbon 105 to an uncurved state in the width direction. As a result, the ink ribbon 105 taken up on the take-up spool 109 is not curved in the width direction. Thus, the cassette 100 can help restrain the ink ribbon 105 from being taken up by the take-up spool 109 while still curled along the width direction, thereby avoiding defects on winding of the ink ribbon 105 on the take-up spool 109.

In the first embodiment, the virtual line S1 passes through a point positioned to the left of the contact portion Z3 between the path-defining part 98D and the ink ribbon 105 when viewed in the up-down direction. Therefore, the path-defining part 98G presses the ink ribbon 105 leftward against the path-defining part 98D. This pressure by the path-defining part 98G causes the rib 97 to further make the ink ribbon 105 into a curved shape along the width direction. Hence, the cassette 100 further helps to suppress skewing of the ink ribbon 105.

In the first embodiment, the virtual line S2 passes through a point positioned to the right of the contact portion Z2 between the path-defining part 98G and the ink ribbon 105 when viewed in the up-down direction. Therefore, the path-defining part 98G presses the ink ribbon 105 leftward against the path-defining part 98D, regardless of the size of the outer diameter of a roll configured of the ink ribbon 105 taken up on the take-up spool 109. As a result, the rib 97 causes the ink ribbon 105 to be curved even more along the width direction. Accordingly, the cassette 100 can further suppress skewing of the ink ribbon 105.

In the first embodiment, the length of the head right peripheral wall 87 in the front-rear direction is smaller than the length of the head rear peripheral wall 85 in the left-right direction. This configuration shortens a distance from the rib 97 to the path-defining part 98D so that the rib 97 causes the ink ribbon 105 to be curved even more along the width direction. Accordingly, the cassette 100 can further help suppress skewing of the ink ribbon 105.

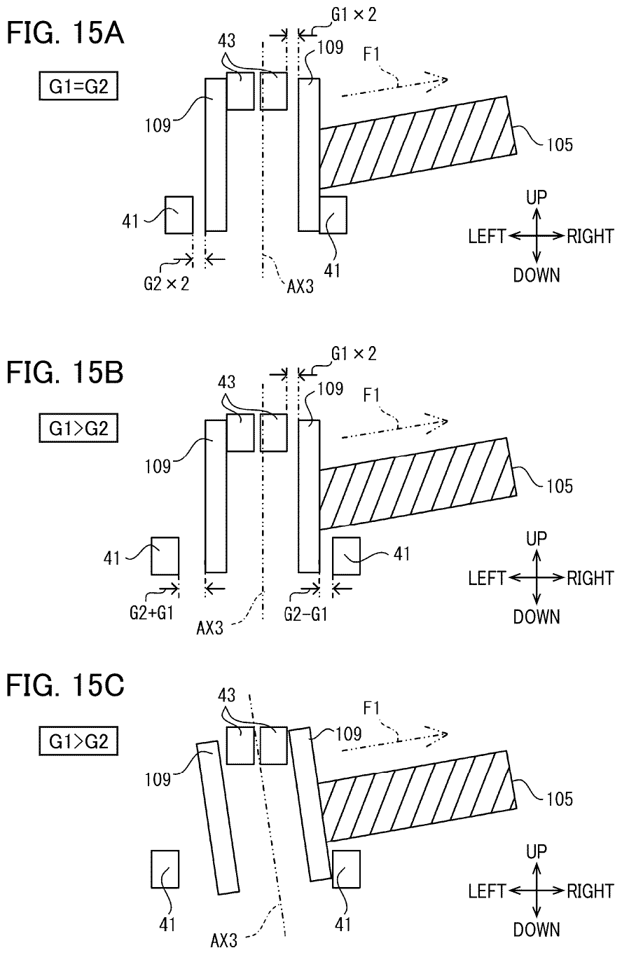

In the first embodiment, in the radial direction of the take-up spool 109, the first gap G1 is formed between the lower end of the take-up spool 109 and the lower support portion 41, and the second gap G2 is formed between the upper end of the take-up spool 109 and the upper support portion 43. FIG. 15A illustrates a case in which, unlike in the first embodiment, the first gap G1 and the second gap G2 illustrated in FIG. 6 have sizes the same as each other. FIGS. 15B and 15C illustrate a case in which the first gap G1 of FIG. 6 is greater than the second gap G2 of FIG. 6, as in the first embodiment.

In the example of FIG. 15A, the take-up spool 109 is moved rightward when a tensile force F1 acts on the ink ribbon 105 in a direction that slopes upward toward rightward. In this case, the lower end of the take-up spool 109 contacts the lower support portion 41 on the right side, and the upper end of the take-up spool 109 contacts the upper support portion 43 on the left side. The contact between the lower end of the take-up spool 109 and the lower support portion 41 and the contact between the upper end of the take-up spool 109 and the upper support portion 43 are nearly simultaneous. Accordingly, the take-up spool 109 rotates while the axis AX3 thereof remains aligned in the up-down direction.

Therefore, in a case where the first gap G1 and the second gap G2 have sizes the same as each other, the ink ribbon 105 is wound about the take-up spool 109 while being gradually shift upward in the axial direction of the take-up spool 109 when the take-up spool 109 takes up the ink ribbon 105 with the tensile force F1 acting on the ink ribbon 105. This action may result in defects in winding of the ink ribbon 105 by the take-up spool 109, such as the ink ribbon 105 contacting the guide disc 109B.

In the first embodiment, the size of the first gap G1 differs from the size of the second gap G2. Hence, when the take-up spool 109 is moved rightward due to the tensile force F1 acting on the ink ribbon 105, as illustrated in FIG. 15B, the upper end of the take-up spool 109 contacts the upper support portion 43 on the left side before the lower end of the take-up spool 109 contacts the lower support portion 41. In other words, the contact between the lower end of the take-up spool 109 and the lower support portion 41 is not simultaneous with the contact between the upper end of the take-up spool 109 and the upper support portion 43.

Hence, at the point in time that the upper end of the take-up spool 109 contacts the upper support portion 43, a gap exists between the lower end of the take-up spool 109 and the lower support portion 41. Accordingly, the lower end of the take-up spool 109 is pivotally moved rightward about the contact portion between the upper end of the take-up spool 109 and the upper support portion 43 on the left side so that the axis AX3 becomes orthogonal to the direction of the tensile force F1, as illustrated in FIG. 15C. As a result, the take-up spool 109 is placed in a state in which the upper end of the take-up spool 109 contacts the upper support portion 43 on the right side and the lower end of the take-up spool 109 contacts the lower support portion 41 on the right side, for example.

When the take-up spool 109 takes up the ink ribbon 105 in this state, the ink ribbon 105 is restrained from shifting in the axial direction of the take-up spool 109 when being taken up thereon. Since the size of the first gap G1 differs from the size of the second gap G2 in the first embodiment, the axis AX3 of the take-up spool 109 tilts along the width direction of the ink ribbon 105 even when the ink ribbon 105 becomes skewed. Accordingly, the cassette 100 can help suppress defective winding of the ink ribbon 105 by the take-up spool 109.

In the first embodiment, the first gap G1 is greater than the second gap G2. This facilitates an operator in assembling the lower cover 70 with the upper cover 80 for the following reason. The operator assembles the lower cover 70 on the upper cover 80 after mounting the take-up spool 109 in the upper cover 80. If the second gap G2 were greater than the first gap G1, the operator would need to assemble the lower cover 70 on the upper cover 80 while the take-up spool 109 supported by the upper support portion 43 is very wobbly.

Since the second gap G2 is smaller than the first gap G1 in the first embodiment, the operator can assemble the lower cover 70 on the upper cover 80 with less wobble in the take-up spool 109 supported by the upper support portion 43. This arrangement reduces the likelihood of the lower cover 70 colliding with the lower end of the take-up spool 109 from below. Accordingly, the cassette 100 helps to facilitate assembly of the lower cover 70 on the upper cover 80.

Further, since the first gap G1 is greater than the second gap G2, the user can easily attach the cassette 100 to the attachment portion 11 for the following reason. The user attaches the cassette 100 to the attachment portion 11 so that the rotational shaft 6 is fitted into the take-up spool 109. Hence, the rotational shaft 6 first passes through the lower end of the take-up spool 109 and subsequently passes through the upper end of the take-up spool 109. If the first gap G1 were formed smaller than the second gap G2, the user would need to attach the cassette 100 to the attachment portion 11 with only a small amount of play in the take-up spool 109 supported by the lower support portion 41.

Since the first gap G1 is greater than the second gap G2 in the first embodiment, the user can attach the cassette 100 to the attachment portion 11 with a greater amount of play in the take-up spool 109 supported by the lower support portion 41. This arrangement reduces the likelihood that the lower end of the take-up spool 109 will collide with the rotational shaft 6 from above when the rotational shaft 6 is guided into the take-up spool 109. Accordingly, the cassette 100 helps facilitate the user in attaching the cassette 100 to the attachment portion 11.

In a case where the absolute value of the difference between the first gap G1 and the second gap G2 is greater than the thickness T3 of the lower support portion 41 in the up-down direction, the take-up spool 109 may come out of the lower support portion 41 when the take-up spool 109 is tilted. In the first embodiment, the absolute value of the difference between the first gap G1 and the second gap G2 is smaller than the thickness T3 of the lower support portion 41 in the up-down direction. Therefore, the cassette 100 can help suppress potential for the take-up spool 109 falling out of the lower support portion 41.

In a case where the absolute value of the difference between the first gap G1 and the second gap G2 is greater than the thickness T4 of the upper support portion 43 in the up-down direction, the take-up spool 109 may come out of the upper support portion 43 when the take-up spool 109 is tilted. In the first embodiment, the absolute value of the difference between the first gap G1 and the second gap G2 is smaller than the thickness T4 of the upper support portion 43 in the up-down direction. Therefore, the cassette 100 helps reduce the likelihood of the take-up spool 109 coming out of the upper support portion 43.

In the first embodiment, the lower support portion 41 is arranged outside the outer circumference of the take-up spool 109 in the radial direction of the take-up spool 109. Therefore, the lower wall 71 is lighter than a configuration in which the lower support portion 41 is arranged inside the inner circumference of the take-up spool 109 in the radial direction, because a hole defined by the lower support portion 41 is larger. In the first embodiment, the upper support portion 43 is arranged inside the inner circumference of the take-up spool 109 in the radial direction of the take-up spool 109. This configuration of the cassette 100 ensures that the thickness T4 of the upper support portion 43 in the up-down direction is sufficiently thick.

Accordingly, the cassette 100 helps reduce the likelihood of the take-up spool 109 coming out of the upper support portion 43. In other words, the configuration of the cassette 100 makes the case 20 lighter while helping to reduce the likelihood of the take-up spool 109 coming out of the upper support portion 43. Further, since the upper support portion 43 is arranged radially inside the inner circumference of the take-up spool 109, the cassette 100 ensures that there is sufficient space for mounting the clutch spring 119 around the upper end of the take-up spool 109.

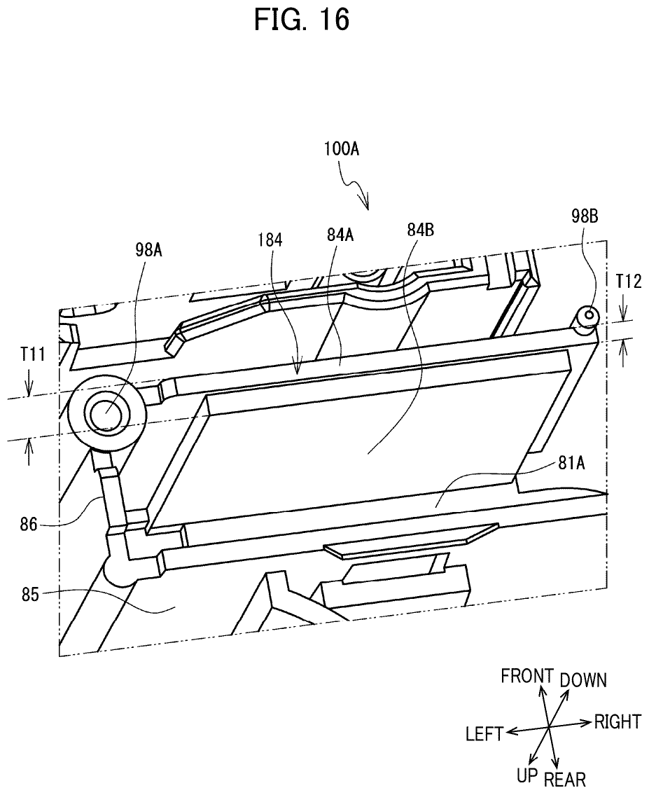

The first embodiment may be modified in various ways. Here, a cassette 100A according to a modification of the first embodiment will be described with reference to FIG. 16. In this modification, the cassette 100A includes a head front peripheral wall 184 in place of the head front peripheral wall 84. The head front peripheral wall 184 includes a protruding portion 84B in addition to the main portion 84A. The protruding portion 84B protrudes rearward from a rear surface of the main portion 84A, and extends in both the up-down direction and the left-right direction. The protruding portion 84B has a plate shape.

A length of the protruding portion 84B in the left-right direction is shorter than a length of the main portion 84A in the left-right direction. A length of the protruding portion 84B in the up-down direction is either the same as or smaller than a length of the main portion 84A in the up-down direction. A length of the protruding portion 84B in the front-rear direction is smaller than the length of the protruding portion 84B in the left-right direction and smaller than the length of the protruding portion 84B in the up-down direction.

In the cassette 100A of this modification, the maximum thickness T11 of the main portion 84A in the front-rear direction is defined by a position in which the protruding portion 84B is present. In other words, the maximum thickness T11 of the main portion 84A in the front-rear direction is equal to a distance in the front-rear direction between a rear edge of the protruding portion 84B and a front surface of the main portion 84A. The maximum thickness T11 of the main portion 84A in the front-rear direction is greater than the distance DI in the front-rear direction between the maximum front surface area and the maximum rear surface area.

The minimum thickness T12 of the main portion 84A in the front-rear direction is defined by positions in which the protruding portion 84B is not present. In other words, the minimum thickness T12 of the main portion 84A in the front-rear direction is equal to a distance in the front-rear direction between the rear surface of the main portion 84A in a portion where the protruding portion 84B is not present and the front surface of the main portion 84A. In the cassette 100A of this modification, the minimum thickness T12 of the main portion 84A in the front-rear direction is either the same as or smaller than the distance D1 in the front-rear direction between the maximum front surface area and the maximum rear surface area.

With the cassette 100A having the above configuration, the weight of the main portion 84A is lighter than a configuration in which the minimum thickness T12 of the main portion 84A in the front-rear direction is greater than the distance D1 in the front-rear direction between the maximum front surface area and the maximum rear surface area. On the other hand, the head front peripheral wall 84 has higher rigidity since the maximum thickness T11 of the head front peripheral wall 84 in the front-rear direction is greater than the distance D1 in the front-rear direction between the maximum front surface area and the maximum rear surface area. Hence, the cassette 100A having this configuration contributes to make the lower case 40 lighter while suppressing skewing of the ink ribbon 105.

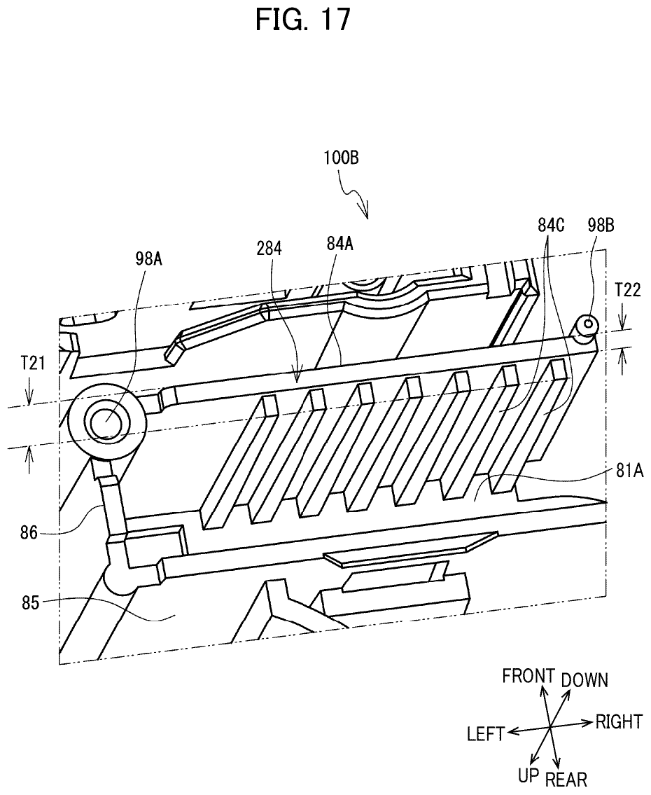

Next, a cassette 100B according to another modification of the first embodiment will be described with reference to FIG. 17. In this modification, the cassette 100B includes a head front peripheral wall 284 in place of the head front peripheral wall 84 or the head front peripheral wall 184. The head front peripheral wall 284 includes a plurality of ribs 84C. The ribs 84C protrude rearward from the rear surface of the main portion 84A and extend in the up-down direction. The ribs 84C are arranged in the left-right direction.

In the cassette 100B according to this modification, the maximum thickness T21 of the main portion 84A in the front-rear direction is defined at positions of the ribs 84C. In other words, the maximum thickness T21 of the main portion 84A in the front-rear direction is equal to a distance in the front-rear direction between rear edges of the ribs 84C and the front surface of the main portion 84A. The maximum thickness T21 of the main portion 84A in the front-rear direction is greater than the distance D1 in the front-rear direction between the maximum front surface area and the maximum rear surface area.

The minimum thickness T22 of the main portion 84A in the front-rear direction is defined at positions of recesses formed between adjacent ribs 84C. In other words, the minimum thickness T22 of the main portion 84A in the front-rear direction is equal to a distance in the front-rear direction between the rear surface of the main portion 84A between the ribs 84C (i.e., bottom surfaces of recessed portions formed by the ribs 84C) and the front surface of the main portion 84A. With the cassette 100B having this configuration, the minimum thickness T22 of the main portion 84A in the front-rear direction is either the same as or smaller than the distance D1 in the front-rear direction between the maximum front surface area and the maximum rear surface area.

The head front peripheral wall 284 in this cassette 100B is even lighter than the head front peripheral wall 184 in the cassette 100A. Accordingly, the cassette 100B can make the lower case 40 even lighter while suppressing skewing of the ink ribbon 105.

Next, other modifications to the first embodiment will be described. The rib 46A may protrude frontward from a rear edge of the opening edge 46, or may be omitted from the lower case 40. The upper case 30 may be omitted from the cassette 100. In this case, the tape roll 103 may be supported in the lower case 40. The tape roll 103 may be omitted from the cassette 100.

The tape insertion opening 44 may not be formed in the intermediate wall 81. In this case, the tape roll 103 may be accommodated in the lower case 40, for example. The upper bridging portion 81A may have a columnar shape that is elongated in the front-rear direction.

The path-defining part 98D need not be provided on the rear edge of the head right peripheral wall 87, but may be provided between the rear edge of the head right peripheral wall 87 and the path-defining part 98G in the front-rear direction, for example. The virtual line S1 may pass through a point positioned on the right side of the contact portion Z3 between the path-defining part 98D and the ink ribbon 105 when viewed in the up-down direction. The virtual line S2 may pass through a point positioned on the left side of the contact portion Z2 between the path-defining part 98G and the ink ribbon 105 when viewed in the up-down direction.

One or both of the path-defining part 98D and the path-defining part 98G may be omitted, for example. In a case where both the path-defining part 98D and the path-defining part 98G are omitted, the ink ribbon 105 is taken up directly on the take-up spool 109 after passing over the rib 97. The length of the head right peripheral wall 87 in the front-rear direction may be the same as or greater than the length of the head rear peripheral wall 85 in the left-right direction.

The first gap G1 may have a size the same as that of the second gap G2. Alternatively, the first gap G1 may be smaller than the second gap G2. The absolute value of the difference between the first gap G1 and the second gap G2 may be the same as or greater than the thickness T3 of the lower support portion 41 in the up-down direction. The absolute value of the difference between the first gap G1 and the second gap G2 may be the same as or greater than the thickness T4 of the upper support portion 43 in the up-down direction. The outer diameter R11 at the lower end of the take-up spool 109 may be the same as or smaller than the inner diameter R12 at the upper end of the take-up spool 109.

The lower support portion 41 may be provided inside the inner circumference of the take-up spool 109 in the radial direction of the take-up spool 109. The upper support portion 43 may be provided outside the outer circumference of the take-up spool 109 in the radial direction of the take-up spool 109. Both the lower support portion 41 and the upper support portion 43 may be arranged radially outside the outer circumference of the take-up spool 109, or radially inside the inner circumference of the take-up spool 109. In a case where the lower support portion 41 is arranged inside the take-up spool 109, the lower support portion 41 may protrude upward from the lower wall 71, for example.

The take-up spool 109 may take up the ink ribbon 105 by rotating in a counterclockwise direction when viewed from below. In this case, the path-defining part 98G may be arranged such that, of the pair of tangents to the outer circumference surface of the take-up spool 109 that pass through the contact portion Z3 between the path-defining part 98D and the ink ribbon 105, the tangent passing along the left of the take-up spool 109 passes on the right side of the contact portion Z2 between the path-defining part 98G and the ink ribbon 105.

### Second Embodiment

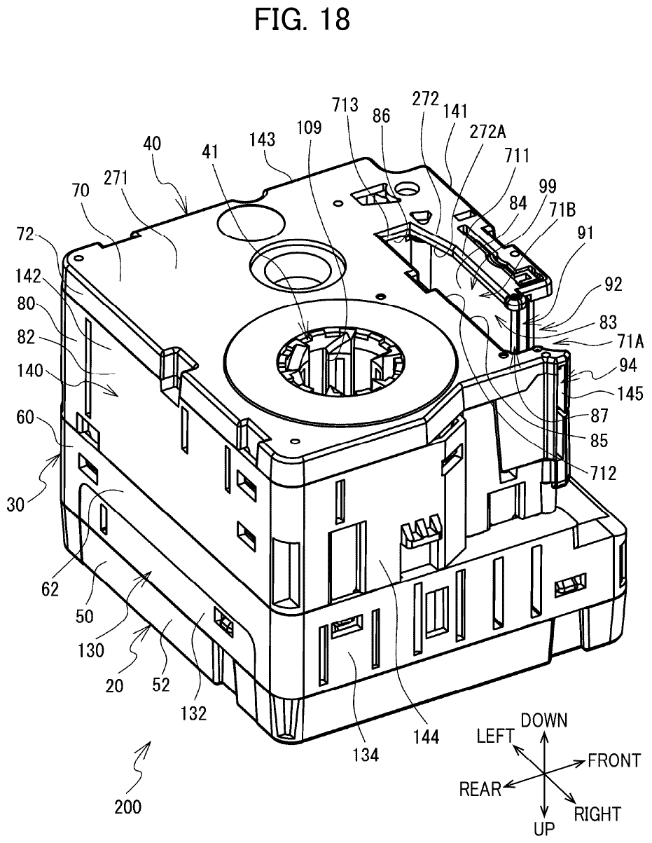

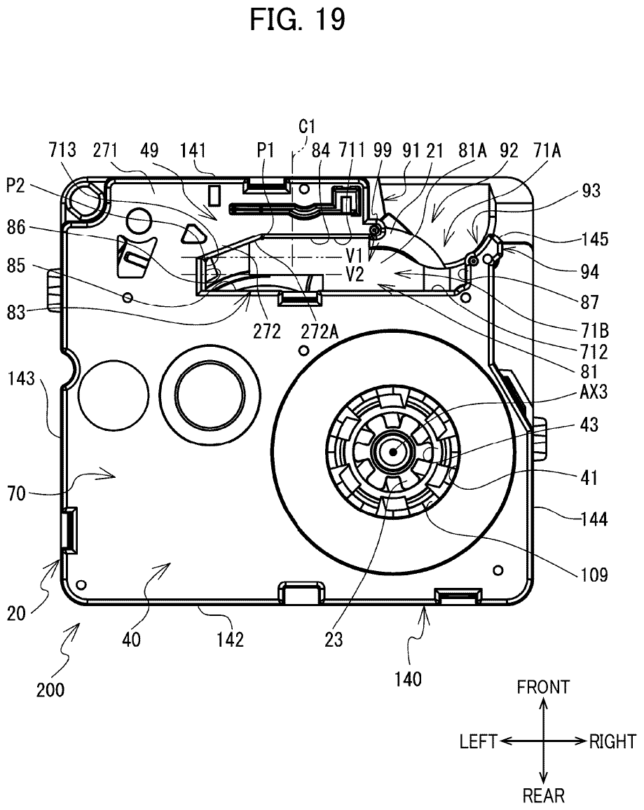

Next, a cassette 200 according to a second embodiment of the present disclosure will be described with reference to FIGS. 18 and 19. Parts and components in the cassette 200 having the same shape or function as those in the cassette 100 will be designated with the same reference numerals, or the reference numerals will be omitted for such parts and components to omit or simplify their description. In the cassette 200 according to the second embodiment, the maximum thickness of the main portion 84A in the front-rear direction may be greater than, smaller than, or the same as a distance in the front-rear direction between the maximum front surface area and the maximum rear surface area.

The cassette 200 is for use in a printer 1, and is used in the same manner as the cassette 100. The cassette 200 differs from the cassette 100 in that the cassette 200 includes a lower wall 271 in place of the lower wall 71. All configurations of the cassette 200 other than the lower wall 271 are the same as those of the cassette 100.

The lower wall 271 has a shape different from the lower wall 71. Specifically, the lower wall 271 includes a lower bridging portion 272 in addition to the structure of the lower wall 71 in the first embodiment. The lower bridging portion 272 is a part of the lower wall 271. Specifically, the lower bridging portion 272 is a portion that spans across and covers from below a part of a space defined by the head front peripheral wall 84, the head rear peripheral wall 85, the head left peripheral wall 86, and the head right peripheral wall 87, i.e., a part of the head opening 99. The lower bridging portion 272 is a wall configuration that extends in both the front-rear direction and the left-right direction.

Here, a centerline C1 will be defined. The centerline C1 is a virtual line extending in the front-rear direction and bisecting the head front peripheral wall 84 in the left-right direction. Next, a front trisector V1 and a rear trisector V2 will be defined. The front trisector V1 and the rear trisector V2 extend in the left-right direction and trisect the head left peripheral wall 86 in the front-rear direction. The front trisector V1 and the rear trisector V2 are arranged from front to rear in this order.

In the following description, a point P1 will refer to a position between the left edge and the right edge of the head front peripheral wall 84 in the left-right direction. In the second embodiment, the point P1 is positioned further leftward relative to the centerline C1. Additionally, a point P2 will refer to a position between the left edge and the right edge of the head rear peripheral wall 85 in the left-right direction or between the front edge and the rear edge of the head left peripheral wall 86 in the front-rear direction. In the second embodiment, point P2 is positioned further rearward relative to the front trisector V1.

A right-rear edge 272A of the lower bridging portion 272 is connected to a front edge 711 of the second notch 71B at the point P1. The right-rear edge 272A extends from the point P1 to the point P2. In the second embodiment, the right-rear edge 272A extends diagonally rearward and leftward from the point P1. The right-rear edge 272A is connected to one of a rear edge 712 and a left edge 713 of the second notch 71B at the point P2. In the second embodiment, the right-rear edge 272A is connected to the left edge 713 of the second notch 71B at the point P2.

As described above, the lower case 40 of the second embodiment includes the lower bridging portion 272. With this configuration, if a force directed rearward acts on the lower edge of the head front peripheral wall 84, the lower bridging portion 272 receives this applied force. This configuration suppresses the lower edge of the head front peripheral wall 84 from bending rearward relative to the upper edge of the head front peripheral wall 84. Accordingly, the cassette 200 can help to suppress skewing of the ink ribbon 105.

In the second embodiment, the point P2 is located further rearward relative to the front trisector V1. With this arrangement, the lower bridging portion 272 can receive a greater amount of the force directed rearward and acting on the head front peripheral wall 84 than a configuration in which the point P2 is positioned further frontward relative to the front trisector V1. Hence, this configuration can better suppress the lower edge of the head front peripheral wall 84 from bending rearward relative to the upper edge of the head front peripheral wall 84, whereby the cassette 200 can further help to suppress skewing of the ink ribbon 105.

In the second embodiment, the point P1 is positioned further leftward relative to the centerline C1. This configuration allocates more space for the head opening 99 in the left-right direction than a configuration in which the point P1 is located further rightward relative to the centerline C1. Accordingly, the cassette 200 can ensure sufficient space for the head opening 99 while suppressing skewing of the ink ribbon 105.

As in the first embodiment described above, the tape insertion opening 44 is formed in the intermediate wall 81 of the second embodiment. Accordingly, the cassette 200 can help facilitate handling of the printing tape 101, as in the first embodiment. As in the first embodiment, the cassette 200 of the second embodiment includes the upper case 30. Accordingly, the cassette 200 can help facilitate handling of the printing tape 101, as in the first embodiment. As in the first embodiment, the rib 46A in the second embodiment protrudes rearward from the opening edge 46. Accordingly, the cassette 200 can help to suppress skewing of the ink ribbon 105, as in the first embodiment.

### Third Embodiment

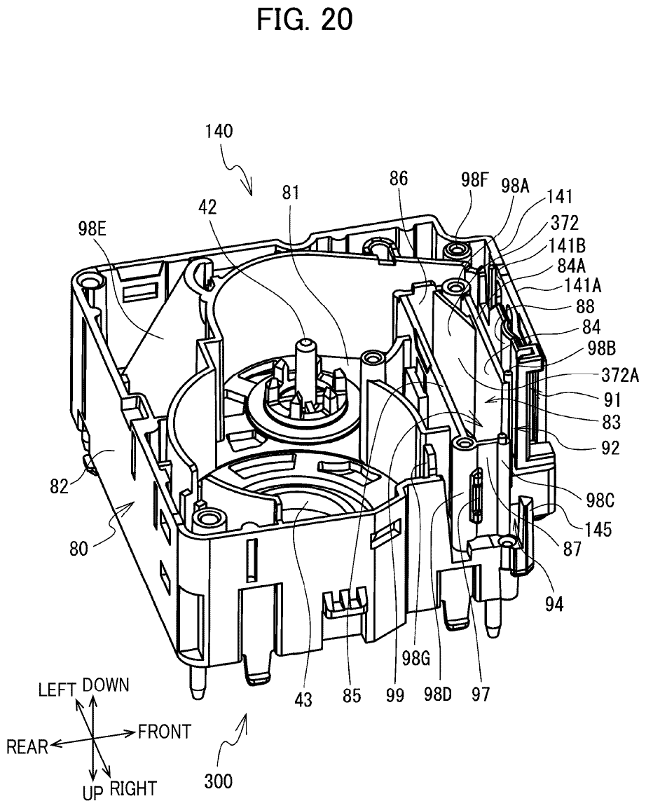

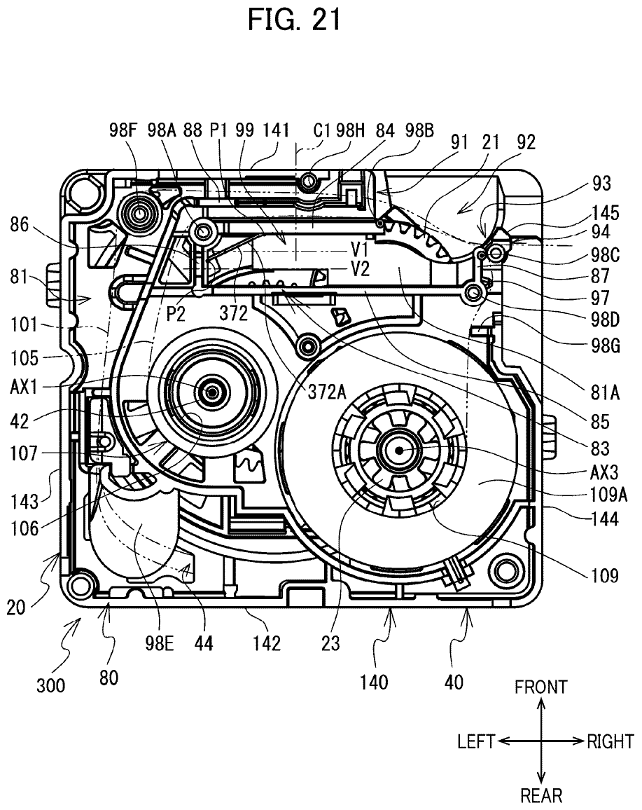

Next, a cassette 300 according to a third embodiment of the present disclosure will be described with reference to FIGS. 20 and 21. The cassette 300 includes the case 20, as in the first embodiment described above. While the case 20 is configured of the upper case 30 and lower case 40, the upper case 30 has been omitted from the drawing in FIG. 20, as has been the lower cover 70 of the lower case 40. In the cassette 300 of the third embodiment, parts and components having the same shape and function as those in the cassette 100 are designated with the same reference numerals to skip or simplify the description. In the cassette 300, the maximum thickness of the main portion 84A in the front-rear direction is greater than, less than, or the same as the distance in the front-rear direction between the maximum front surface area and the maximum rear surface area.

The cassette 300 is also for use in a printer 1, and the manner of use is identical to that of the cassette 100 in the first embodiment. The cassette 300 differs from the cassette 100 in that the lower case 40 includes a center bridging portion 372. The configurations in the cassette 300 other than the center bridging portion 372 are the same as the configurations of the cassette 100.

The center bridging portion 372 is a wall that is part of the upper cover 80. Specifically, the center bridging portion 372 is a portion of the upper cover 80 disposed in a space surrounded by the head front peripheral wall 84, the head rear peripheral wall 85, the head left peripheral wall 86, and the head right peripheral wall 87, i.e., the head opening 99. The center bridging portion 372 extends in the up-down direction. The center bridging portion 372 extends leftward as extending rearward.

The center bridging portion 372 has a right-rear edge 372A. The right-rear edge 372A is connected to the head front peripheral wall 84 at the point P1. The right-rear edge 372A extends from the point P1 to the point P2. The right-rear edge 372A is connected to either the head rear peripheral wall 85 or the head left peripheral wall 86 at the point P2. In the third embodiment, the right-rear edge 372A is connected to the head left peripheral wall 86 at the point P2.

As in the second embodiment described above, the point P1 in the third embodiment is located further leftward relative to the centerline C1. Further, the point P2 is located further rearward relative to the front trisector V1. The point P2 is at a position in the front-rear direction between the front edge and the rear edge of the head left peripheral wall 86.

As described above, the lower case 40 of the third embodiment includes the center bridging portion 372. With this configuration, if a force directed rearward acts on the lower edge of the head front peripheral wall 84, the center bridging portion 372 receives the applied force. Therefore, this configuration suppresses the lower edge of the head front peripheral wall 84 from bending rearward relative to the upper edge of the head front peripheral wall 84. Accordingly, the cassette 300 can help suppress skewing of the ink ribbon 105.

As in the second embodiment described above, the point P2 in the third embodiment is positioned further rearward relative to the front trisector V1. Accordingly, the cassette 300 can better help suppress skewing of the ink ribbon 105, as in the second embodiment. As in the second embodiment, the point P1 in the third embodiment is positioned further leftward relative to the centerline C1. Accordingly, the cassette 300 can ensure sufficient space in the head opening 99 while suppressing skewing of the ink ribbon 105, as in the second embodiment.

As in the first embodiment described above, the tape insertion opening 44 of the third embodiment is formed in the intermediate wall 81. Accordingly, the cassette 300 can help facilitate handling of the printing tape 101, as in the first embodiment. As in the first embodiment, the cassette 300 of the third embodiment includes the upper case 30. Accordingly, the cassette 300 can help facilitate handling of the printing tape 101, as in the first embodiment. As in the first embodiment, the rib 46A in the third embodiment protrudes rearward from the opening edge 46. Accordingly, the cassette 300 can help suppress skewing of the ink ribbon 105, as in the first embodiment.

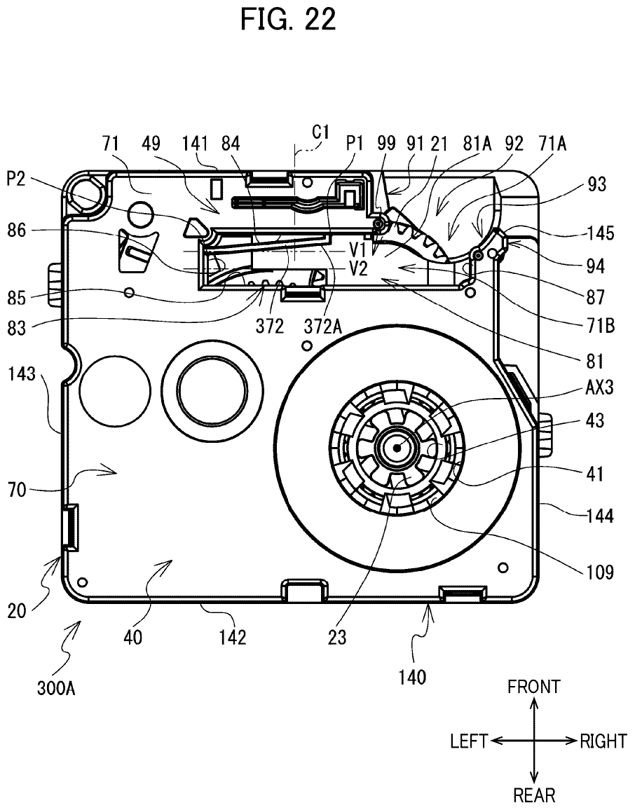

The second embodiment and the third embodiment may be modified in various ways. For example, FIG. 22 illustrates a cassette 300A according to a modification of the third embodiment. As illustrated in FIG. 22, the point P1 in the cassette 300A is located at a position further rightward relative to the centerline C1. Similarly, the point P1 may be located at a position further rightward relative to the centerline C1 in the second embodiment.

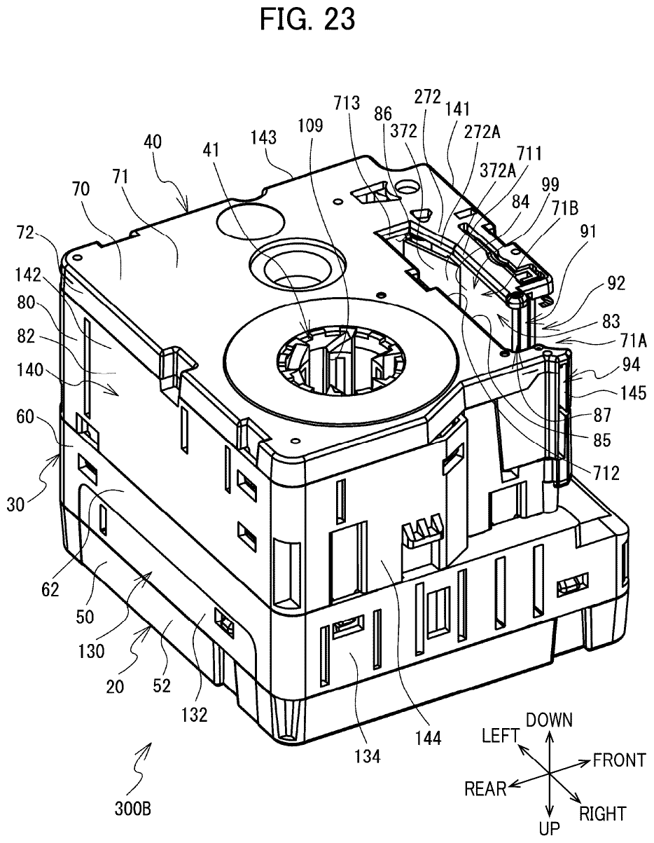

FIG. 23 illustrates a cassette 300B according to a modification of the second embodiment or the third embodiment. In the cassette 300B illustrated in FIG. 23, the lower case 40 includes both the lower bridging portion 272 and the center bridging portion 372.

Other modifications of the second embodiment and the third embodiment will be described. In the second embodiment or the third embodiment, the point P2 may be located at the same position as the front trisector V1 in the front-rear direction, or may be located at a position further frontward relative to the front trisector V1. The second embodiment and the third embodiment may be modified in similar ways to the first embodiment as long as there are no inconsistencies.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

### <Remarks>

The cassettes 100, 100A, 100B, 200, 300, 300A, and 300B are each an example of the “cassette”. The lower case 40 is an example of the “lower case”. The ribbon roll 107 is an example of the “ribbon roll”. The ink ribbon 105 is an example of the “ink ribbon”. The axis AX1 is an example of the “first axis”. The take-up spool 109 is an example of the “take-up spool”. The front wall 141 is an example of the “front wall”. The rear wall 142 is an example of the “rear wall”. The left wall 143 is an example of the “left wall”. The right wall 144 is an example of the “right wall”. The head front peripheral wall 84 is an example of the “first inner wall”. The head rear peripheral wall 85 is an example of the “second inner wall”. The head left peripheral wall 86 is an example of the “third inner wall”. The head right peripheral wall 87 is an example of the “fourth inner wall”. The exposed area 92 is an example of the “exposed area”. The rib 97 is an example of the “protrusion”. The path-defining part 98D is an example of the “first path-defining part”. The contact portion Z3 is an example of the “first contact portion”. The path-defining part 98G is an example of the “second path-defining part”. The contact portion Z2 is an example of the “second contact portion”. The contact portion Z1 is an example of the “third contact portion”. The virtual line S1 is an example of the “first straight line”. The virtual line S2 is an example of the “second straight line”. The lower wall 71 is an example of the “first wall”. The intermediate wall 81 is an example of the “second wall”. The outer peripheral wall 140 is an example of the “peripheral wall”. The tape insertion opening 44 is an example of the “insertion opening”. The printing tape 101 is an example of the “printing medium”. The upper case 30 is an example of the “upper case”. The tape roll 103 is an example of the “medium roll”. The axis AX2 is an example of the “second axis”.

What is claimed is:

1. A cassette comprising:
a lower case having a box-like shape;
a ribbon roll accommodated in the lower case, the ribbon roll being a roll of an ink ribbon, the ribbon roll being rotatable about a first axis extending in an up-down direction; and
a take-up spool accommodated in the lower case, the take-up spool being configured to take up the ink ribbon from the ribbon roll,
wherein the lower case comprises:
a front wall extending in both the up-down direction and a left-right direction orthogonal to the up-down direction, the front wall having a right edge;
a rear wall extending in both the up-down direction and the left-right direction, the front wall and the rear wall being arranged in a front-rear direction orthogonal to both the up-down direction and the left-right direction;
a left wall extending in both the up-down direction and the front-rear direction;
a right wall extending in both the up-down direction and the front-rear direction, the left wall and the right wall being arranged in the left-right direction, the right wall having a front edge;
a first inner wall extending in both the up-down direction and the left-right direction, the first inner wall being positioned between the front wall and the rear wall, the first inner wall having a left edge and a right edge;
a second inner wall extending in both the up-down direction and the left-right direction, the second inner wall being positioned between the front wall and the rear wall and positioned further rearward relative to the first inner wall in the front-rear direction, the second inner wall having a left edge and a right edge;
a third inner wall extending in both the up-down direction and the front-rear direction, the third inner wall being positioned between the left wall and the right wall, the third inner wall having a front edge connected to the left edge of the first inner wall and a rear edge connected to the left edge of the second inner wall; and
a fourth inner wall extending in both the up-down direction and the front-rear direction, the fourth inner wall being positioned between the left wall and the right wall and positioned further rightward relative to the third inner wall in the left-right direction, the fourth inner wall having a front edge and a rear edge connected to the right edge of the second inner wall,
wherein the lower case has an exposed area in which the ink ribbon is exposed, the exposed area extending from a portion between the right edge of the front wall and the right edge of the first inner wall to a portion between the front edge of the fourth inner wall and the front edge of the right wall, and
wherein the lower case defines a conveying path along which the ink ribbon is conveyed in a conveying direction when the take-up spool takes up the ink ribbon from the ribbon roll, the conveying path including a first part, a second part, the exposed area, and a third part from an upstream side in the conveying direction, the first part passing between the left wall and the third inner wall, the second part passing between the front wall and the first inner wall, the third part passing between the fourth inner wall and the right wall,
the cassette further comprising:
a protrusion protruding rightward from a portion of the fourth inner wall other than the front edge and the rear edge of the fourth inner wall, the protrusion being configured to contact a widthwise center portion of the ink ribbon to cause the ink ribbon to be curved along a width of the ink ribbon so that the widthwise center portion of the ink ribbon protrudes rightward.

2. The cassette according to claim 1,
wherein the lower case further comprises:
a first path-defining part provided on the rear edge of the fourth inner wall and defining the conveying path,
wherein the ink ribbon is configured to contact the first path-defining part in an entirety of the width of the ink ribbon to have a first contact portion with the first path-defining part, the first contact portion having a straight-line shape extending in the up-down direction when viewed in a longitudinal direction of the ink ribbon.

3. The cassette according to claim 2,
wherein the lower case further comprises:
a second path-defining part provided further rearward relative to the first path-defining part, the second path-defining part being positioned on an opposite side of the ink ribbon from the first path-defining part when viewed in the up-down direction, the second path-defining part defining the conveying path,
wherein the ink ribbon is configured to contact the second path-defining part to have a second contact portion with the second path-defining part, the second contact portion being positioned downstream of the first contact portion in the conveying direction,
wherein the ink ribbon is configured to contact the protrusion to have a third contact portion with the protrusion, and
wherein the second contact portion and the third contact portion define a first straight line passing through the second contact portion and the third contact portion, the first straight line passing through a point positioned to a left of the first contact portion when viewed in the up-down direction.

4. The cassette according to claim 3,
wherein the conveying path further includes a fourth part positioned downstream of the third part in the conveying direction, the fourth part passing between the right wall and a center of the take-up spool, and
wherein the first contact portion and the take-up spool define a second straight line passing through the first contact portion and tangential to an outer circumferential surface of the take-up spool at a position rightward of the center of the take-up spool, the second straight line passing through a point positioned to a right of the second contact portion when viewed in the up-down direction.

5. The cassette according to claim 1,
wherein the lower case further comprises:
a first wall extending in both the front-rear direction and the left-right direction;
a second wall extending in both the front-rear direction and the left-right direction, the first wall and the second wall being arranged in the up-down direction; and
a peripheral wall extending between the first wall and the second wall, the peripheral wall comprising the front wall, the rear wall, the left wall, and the right wall,
wherein the second wall has an insertion opening allowing a printing medium to be inserted into the lower case therethrough,
wherein the lower case further defines a conveying path along which the printing medium is conveyed in a conveying direction, the conveying path of the printing medium including the insertion opening, a first part, a second part, and the exposed area from an upstream side in the conveying direction of the printing medium, the first part of the conveying path of the printing medium passing between the left wall and the third inner wall, the second part of the conveying path of the printing medium passing between the front wall and the first inner wall, and
wherein the ink ribbon and the printing medium are configured to be superimposed with each other in the exposed area.

6. The cassette according to claim 5, further comprising:
an upper case having a box-like shape, the upper case being positioned further upward relative to the lower case, wherein the first wall is positioned further downward relative to the second wall; and
a medium roll accommodated in the upper case, the medium roll being a roll of the printing medium, the medium roll being rotatable about a second axis extending in the up-down direction,
wherein the printing medium is configured to be drawn off the medium roll and to be inserted into the lower case through the insertion opening.
